(19) United States
(12) Patent Application Publication
(10) Pub. No.: US 2010/0162549 A1
(43) Pub. Date: Jul. 1, 2010

(54) APPARATUS FOR RECYCLING BINDER COMPONENTS

(75) Inventor: Derek Tryhorn, KENT (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BLL HOLDINGS LIMITED

(21) Appl. No.: 12/664,042

(22) PCT Filed: Jun. 4, 2008
(86) PCT No.: PCT/GB08/01903

§ 371 Date: Feb. 4, 2010

(30) Foreign Application Priority Data
Jun. 14, 2007 (GB) 0711467.1

(51) Int. Cl. B23P 19/04

(52) U.S. Cl. 29/426.4; 29/237.5

(57) ABSTRACT

Apparatus for removing binder mechanisms (12) from binders (10), the apparatus comprising: a transport mechanism for transporting binders in series through the apparatus; an alignment mechanism (16) configured to align the binder mechanisms with a predetermined datum relative to the apparatus; a rivet releasing mechanism (24) positioned relative to the predetermined datum for releasing at least one rivet holding each binder mechanism to its respective binder; a binder mechanism removal mechanism (75) for removing each binder mechanism from its respective binder once the at least one rivet has been released by the rivet releasing mechanism; and an indexing mechanism (18) for indexing transport of binders through the apparatus in synchronism with operation of the rivet releasing mechanism.

### FIELD OF THE INVENTION

The present invention relates to a method and apparatus for recycling the components of binders, including ring binders and lever arch files.

### BACKGROUND OF THE INVENTION

As consumers become increasingly environmentally aware, there is a growing desire to recycle components from many common products, including binders for filing, storage and presentation of loose leaf papers and documents. Typically such binders comprise metallic binder mechanisms mounted on binder flats. The binder mechanisms normally comprise metal plates mounted to the binder flat by metal rivets. Metal bars forming the binder loops extend from the metal plates. The binder loops may be in the form of rings which are opened and closed by finger operation. Such a binder is known as a ring binder. Alternatively, the binder may be a lever arch file in which the binder mechanism is a lever arch mechanism in which the binder loops have an arcuate form and are actuated by a lever.

The lever arch mechanism may also normally be combined with the employment of RADO™ rings and/or finger ring. A RADO™ ring is an elongate thin metal eyelet in the front panel of a binder through which an upper portion of a corresponding binder lever arch mechanism loop passes when the binder is in a closed position. Each RADO™ ring comprises a protrusion which engages with the binder loop to assist in retaining the binder in a closed position. RADO™ rings are generally used in pairs. A finger ring is a large circular thin metal eyelet, typically 30 mm in diameter, mounted to the spine of the binder. A user may withdraw a binder from a shelf or the like by inserting a finger through the finger ring and pulling. The RADO™ and finger rings are inserted into pre-punched holes during production of the binder and retained in position by the swaging over of their inner edge to form a retaining lip.

The binder flats are normally made from PVC, polypropylene or paper. A PVC flat generally comprises a layer of stiff cardboard or board fully sealed and sandwiched between two PVC skins. Other types of flats may also have skins which form a cover and which may be made from polypropylene or paper. The inner board layer commonly comprises two side panels and a central spine board, all of varying width. The perimeter edges of the skins and the areas separating the side panels from the spine board are welded together, often by high frequency (HF) welding. For recycling purposes the cardboard must be separated from the PVC envelope.

It is known to separate the components manually. For example, the metal mechanism components may be removed manually by drilling out the rivets one at a time to release the mechanism. The spine and side boards may be separated from the PVC cover by slitting the cover of each panel from upper corners diagonally to its lower corners pulling them out through the slits along the edges of the side boards close to the spine board. The side boards may then be extracted by pulling them out through the slits. However, these manual processes are not economic given the relatively low value of the components retrieved from a standard binder.

DE19819650 discloses a binder separating and emptying device employing several steps. There is, however, no disclosure of how the various steps might be automated.

### SUMMARY OF INVENTION

According to a first aspect of the invention there is provided apparatus for removing binder mechanisms from binders, the apparatus comprising:

a transport mechanism for transporting binders in series through the apparatus;

an alignment mechanism configured to align the binder mechanisms with a predetermined datum relative to the apparatus;

a rivet releasing mechanism positioned relative to the predetermined datum for releasing at least one rivet holding each binder mechanism to its respective binder;

a binder mechanism removal mechanism for removing each binder mechanism from its respective binder once the at least one rivet has been released by the rivet releasing mechanism; and

an indexing mechanism for indexing transport of binders through the apparatus in synchronism with operation of the rivet releasing mechanism.

The binder may be a ring binder or a lever arch file as defined above. In the manual removal process, the rivets are drilled out one at a time by an operator. This process is time consuming and uneconomical. In contrast, the above invention provides an automated process for retrieving the metal components from a binder.

Each of the alignment, rivet detection and rivet removal operations may require the binder to be momentarily stationary and the indexing system ensures that the binder is stationary as required. The indexing system may comprise a swing arm having a forward and backward motion and at least one moveable beam connected to the swing arm whereby the beam pushes a binder forwards during the forward motion of the swing arm. The stationary period may occur during the backward motion of the swing arm.

The indexing system may comprise a moveable member configured to engage and move a binder forwards, the moveable member being kinematically connected to an intermittent driver synchronised with the operation of the rivet releasing mechanism. The moveable member may be attached to a chain driven by the intermittent driver.

The apparatus may comprise a sensing mechanism for sensing the location of said at least one rivet holding the binder mechanism to the binder. The sensing mechanism may comprise an array of sensors which detect the location of the at least one rivet. The sensed location may be compared against known references and/or the location of the edge of the binder.

The rivet removal mechanism may comprise a punch head which is adjustable depending on the sensed location of the rivets. The punch head may be operated pneumatically to punch out the rivets.

Alternatively, the rivet removal mechanism may comprise means to mill the rivets. The milling means may be a vertical mill or a horizontal mill which may be driven by an electric motor. Vertical milling is typically used for profiling and plunge cutting of metal. Horizontal milling is typically used for surface and side milling.

A horizontal mill may comprise a cutter and a drive shaft both of which are mounted horizontally. The cutter may be cylindrical with a bore running along its central axis for receiving the drive shaft and helical cutting edges mounted on its outer surface. Spacer rings may also be mounted on the drive shaft to position the cutter in the desired position. The mill may comprise a locking nut which is screwed to one end of the shaft and which comprises a key which engages with a corresponding cut-out in the bore of the cutter to prevent the cutter from rotating on the drive shaft in use.

A vertical mill may comprise a cutter, a holding chuck and a drive shaft which are all mounted vertically. The cutter may be metal. The cutter may be held direct in the holding chuck or may be attached to an arbor which is held in the holding chuck. A horizontal mill cutter is typically of much larger diameter and width than that of a vertical mill and is thus typically more robust.

Milling also allows the mechanised removal of RADO™ and finger rings as well as the lever arch mechanism. This may be done by milling the retaining portions of the RADO™ and finger rings and by milling the rivets for the lever arch mechanism. To this end, the milling means may be spaced transversely to the direction of transport of the binder through the apparatus. In contrast, it is not possible to remove RADO and finger rings manually.

The indexing mechanism may be configured to hold the binder stationary while at least one rivet of said binder is being released by said rivet releasing mechanism. The indexing mechanism may comprise a clamp actuable to engage the binder flat and hold the binder stationary. The milling means may be configured to move relative to said stationary binder.

The binder mechanism removal mechanism may comprise a clamp assembly which clamps around the binder mechanism and which may be operated pneumatically. The clamp assembly may be rotatable to rotate a clamped binder mechanism away from the binder once the rivets have been removed. The rivet removal mechanism and binder mechanism removal mechanism may thus be operated cooperatively and possibly simultaneously.

The alignment mechanism may be configured to abut the binder mechanisms of the binders when transported in series. The alignment mechanism may have two opposing surfaces configured to abut the binder mechanism of a binder. The two opposing surfaces may extend primarily in the direction of transport of the binder through the apparatus. Where a binder mechanism comprises at least two loops spaced along a common axis, each of said two opposing surfaces may be configured to abut a loop of the binder mechanism in a direction perpendicular to said common axis.

The alignment mechanism may comprise a further alignment mechanism comprising a pair of guides configured to move in an equal and parallel movement towards the edges of a binder whereby the binder is aligned correctly relative to the apparatus. The guides may be coupled together by connecting rods which operate in a scissor action. The alignment mechanism may comprise a sensor which detects the presence of a binder with movement of the guides commencing after this detection. The alignment mechanism may comprise a pair of sensors which detect when the guides contact each side of the binder. The alignment mechanism preferably centres the binder mechanism relative to a central axis running along the length of the apparatus. This central axis is also consistent with the axis of the punch head of the rivet removal mechanism.

The binder may initially be placed on a conveyor belt. In this way, safety separation between an operator and the rest of the apparatus is provided and there is a buffer capacity to the infeed process.

The apparatus may further comprise at least one moveable jaw configured to engage an edge runner of said binder and move relative to said binder, thereby at least partially separating said runner from said binder. The indexing mechanism may be configured to hold the binder stationary while said moveable jaw is in engagement with said edge runner. The indexing mechanism may comprise a clamp actuable to engage the binder flat and hold the binder stationary. The apparatus may further comprise a member insertable between said runner and said binder, thereby to separate said runner and said binder.

According to a second aspect of the invention there is provided apparatus for processing a binder flat having at least one board component and a cover on the board component, the apparatus comprising a transport mechanism for transporting a binder flat through the apparatus, an alignment station for correctly aligning a binder flat placed in the apparatus, a cropping station for removing the leading and trailing sides of the aligned binder flat and a board eject station for ejecting the at least one board component through the cropped edges of the binder flat.

Often, binders have rounded corners. Such rounded corners are an obstruction to the removal of the internal board components. This is addressed in the manual process by slitting the cover of each panel from upper corners diagonally to its lower corners and removing the board components through this slit. In contrast, in the present invention the cropping station removes the leading and trailing sides of the binder flat and hence removes any rounded corners on the binder flat. This allows the board eject station to remove the at least one board component through an open or cropped edge.

The board eject station comprises at least one pusher blade which is set so that the pusher blade contacts the at least one board component through the cropped leading edge of the binder flat. The board eject station may comprise a removal support which support the at least one board component as it is removed from the binder flat. The removal support may be a hinged flap which is rotatable between a first position in which the flap supports the board component and a second position in which the flap is free to fall downwards. The flap may be electro/pneumatically operated.

The at least one board component may comprise a spine board and two side panel boards. The board eject station may comprise a spine support for supporting the binder flat as the side panel boards are removed. The spine support exerts little or no pressure on the side panel boards so that they may be freely removed. The spine support may comprise rollers having a width corresponding to that of the spine board. The board eject station may comprise side panel supports for supporting the binder flat as the spine bₒₐᵣd is removed. The side panel supports may comprise rollers having a reduced thickness at their centre whereby little or no pressure is applied to the spine area of a binder flat so that the spine board may be removed. The spine support and/or the side panel supports may also transport the binder flat through the board eject station and thus may form part of the transport mechanism for forcing the binder flat through the apparatus.

The board eject station may comprise a spine eject station and a side panel eject station with the side panel supports forming part of the spine eject station and the spine supports part of the side panel eject station. The use of specially designed supports is different to the manual process in which the product is supported on a table or by an operator. An operator may readily change his grip on the binder so as to change the support applied to the product to enable the board components to be removed.

The alignment station may comprise a pair of guides configured to move in an equal and parallel movement towards the edges of a binder flat whereby the binder flat is aligned correctly relative to the apparatus. The guides may be coupled together by connecting rods which operate in a scissor action. The alignment station may comprise a sensor which detects the presence of a binder flat with movement of the guides commencing after this detection. The alignment station may comprise a pair of sensors which detect when the guides contact each side of the binder flat. The alignment station preferably centres the binder flat relative to a central axis running along the length of the apparatus.

The apparatus may further comprise a slitting station for slitting the cover before the binder flat is fed to the board eject station. Slitting the cover preferably breaks any seal between the cover and board component so that the at least one board component may be ejected by the board eject station. The slitting station may comprise at least one slitting knife which is set so that the knife slits only the cover and not the at least one board component as a binder flat passes through the slitting station. The slitting station may comprise an adjustment mechanism to compensate for different thicknesses of binder flat. The adjustment mechanism may comprise a support plate which supports the binder flat and which is mounted pneumatically whereby the pneumatic pressure applied to the support plate is varied according to the thickness of the binder flat.

The apparatus may further comprise a cutting station whereby the binder flat is cut to a standard width before being fed to subsequent stations. For most automatic equipment to perform satisfactorily, the materials or components to be processed require a reasonable degree of uniformity. Standardising the width assists this automated apparatus to perform satisfactorily. The cutting station may comprise a pair of blades set apart by a predetermined distance which may be equal to the standard width of a binder, i.e. 635 mm.

The transport mechanism may comprise an infeed station which ensures that the binder flats are correctly timed through each of the stations located downstream therefrom. The infeed station may comprise a rotary magazine having a plurality of hoppers which are rotatable so that one hopper is being filled with binder flats whilst binder flats are being fed into the apparatus from another hopper. The infeed station may further comprise a first conveyor belt on which binder flats are placed, e.g. by hand, and fed to the rotary magazine. The infeed station may comprise a second conveyor belt on to which binder flats are placed from the rotary magazine. The use of a rotary magazine permits continuous operation of the process by smoothing out the effect of varying rates of infeed from the first conveyor belt.

The infeed station preferably ensures that the binder flats are correctly positioned for feeding into the alignment station. In other words, the binder flats are positioned with the axis of the spine board parallel to the central axis running along the length of the apparatus.

The board eject station is located downstream and the alignment station is located upstream from the various cutting, slitting and cropping stations. The transport mechanism may further comprise a series of rollers which force the binder flat through the slitting and cropping stations.

According to another aspect of the invention, there is provided apparatus for separating a binder into its various components, the apparatus comprising apparatus for removing the binder mechanism as described above and apparatus for processing a binder flat as described above. Alternatively, either apparatus may be combined with a manual process to remove the other components.

According to another aspect of the invention there is provided an automated method for removing binder mechanisms from binders, the method comprising:

aligning the binder mechanisms with a predetermined datum relative to the apparatus;

releasing at least one rivet holding each binder mechanism to its respective binder by means of a rivet releasing mechanism positioned relative to the predetermined datum;

removing each binder mechanism from its respective binder once the at least one rivet has been released by the rivet releasing mechanism; and

indexing the binders in series through the apparatus in synchronism with operation of the rivet releasing mechanism.

According to another aspect of the invention there is provided an automated method for processing a binder flat having at least one board component and a cover on the board component, the method comprising correctly aligning a binder flat, cropping the aligned binder to remove the leading and trailing edges of the binder flat, and ejecting the at least one board component through the cropped edges of the binder flat.

The method aspects of the invention can be particularlised using features of the apparatus described above.

### BRIEF DESCRIPTION OF THE DRAWINGS

Embodiments of the invention will now be described by way of example, and with reference to the accompanying figures, in which:

FIGS. 1a and 1b are plan and side views of a first embodiment of apparatus for removing the binder mechanism from a binder according to the present invention;

FIGS. 2a and 2b are plan and side views of the feed and preliminary centring mechanisms of the embodiment of FIG. 1a;

FIGS. 2c and 2d are plan and side views of a second embodiment of the feed and preliminary centring mechanisms;

FIGS. 3a and 3b are plan and side views of the indexing transport system of the embodiment of FIG. 1;

FIGS. 3c and 3d are detailed views showing the system when loaded with binders;

FIGS. 3e and 3f are side views of pusher block of the indexing transport system of FIGS. 3a and 3b;

FIGS. 3g and 3h are plan and side views of a second embodiment of the indexing transport system;

FIGS. 4a and 4b are plan and side views of the final centring mechanism of the embodiment of FIG. 1;

FIGS. 4c and 4d are plan and side views of the rivet detection mechanism of the embodiment of FIG. 1;

FIGS. 4e and 4f are plan and side views of the binder removal mechanism of the embodiment of FIG. 1;

FIGS. 4g and 4h are side and end views of the clamping mechanism of the binder removal mechanism of FIG. 1;

FIGS. 4i and 4j are plan and side views of a second embodiment of the binder removal mechanism;

FIGS. 5a and 5b are plan and side views of the outfeed mechanism of the embodiment of FIG. 1a;

FIGS. 5c and 5d are plan and side views of a second embodiment of the outfeed mechanism;

FIGS. 5e and 5f are plan and side views of apparatus incorporating all the second embodiments above.

FIGS. 6a and 6b are plan and side views of apparatus for separating the binder components following removal of the binder mechanism;

FIGS. 7a and 7b are plan and side views of the feed mechanism of the apparatus of FIG. 6a;

FIGS. 8a and 8b are plan and side views of the rotary magazine and pick and place mechanisms of the apparatus of FIG. 6a;

FIGS. 9a and 9b are plan and side views of the centring and first cutting mechanisms of the apparatus of FIG. 6a;

FIGS. 10a and 10b are plan and side views of the second and third cutting mechanisms and the spine board removal mechanism of the apparatus of FIG. 6a;

FIGS. 11a and 11b are plan and side views of the mechanisms for removing the remaining components of the binder;

FIGS. 12a and 12b are perspective views of the pusher blades of the board removal mechanisms, and

FIGS. 13a, 13b and 13c are cross-sectional, plan and end section views of an alternative second cutting mechanism of the apparatus of FIG. 6a.

### DETAILED DESCRIPTION OF THE DRAWINGS

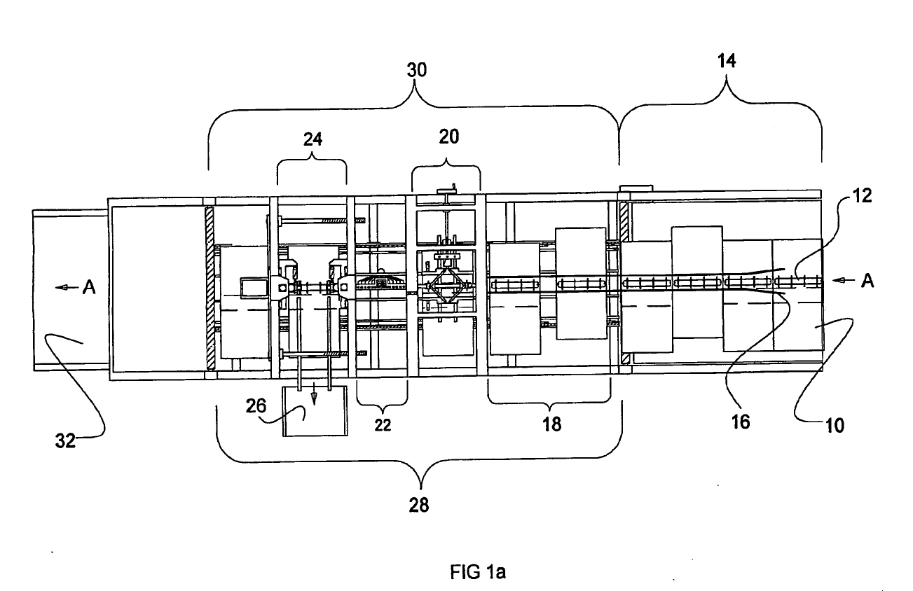

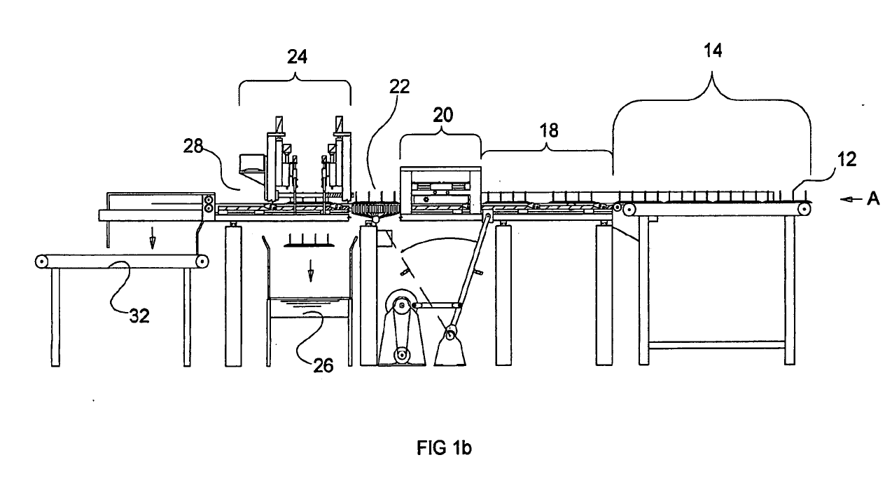

FIGS. 1a and 1b show apparatus for the automated removal of the binder mechanism 12 from a binder 10. A binder 10 with mechanism attached is placed (by hand) on a first or infeed conveyor belt 14. The binder 10 travels in the direction of arrow A through a centring mechanism 16 which aligns the binder mechanism 12 with the centre of the conveyor belt 14.

The centred binder passes to indexing mechanism 18 which ensures that there is sufficient space between each binder to correctly time with the next four mechanisms, including the final centring and rivet removal mechanisms. The final centring mechanism 20 ensures that the binder is correctly aligned to pass into the rivet detection mechanism 22. As described in more detail below, the centring mechanism ensures that the binder mechanism is axially aligned with the centre of the machine and hence the de-riveting head. The rivet detection mechanism detects the position of the rivets relative to this axis. This information is used to automatically adjust the rivet removal mechanism.

After the detection mechanism 22, the binder is fed to the rivet removal and collection mechanism 24. which removes the rivet based on information collected by the preceding mechanism. The ejected rivets, removed ring or lever arch mechanisms are collected on a feed away conveyor belt 26. The binder flat, i.e. the binder with binding mechanism removed, is transported out to a second or out feed conveyor belt 32 by a transport mechanism 28 which is part of the indexed transport system 30.

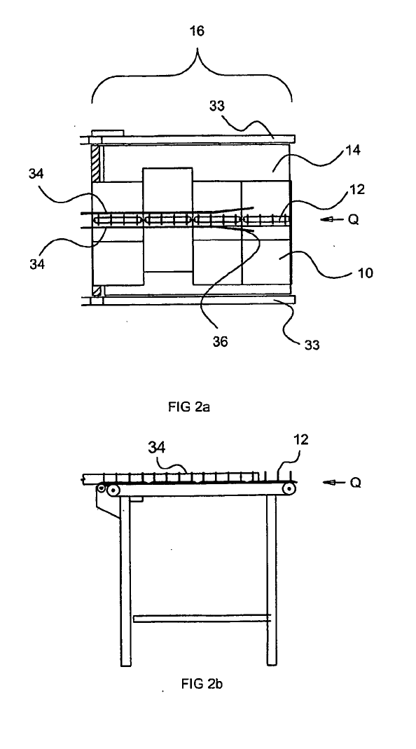

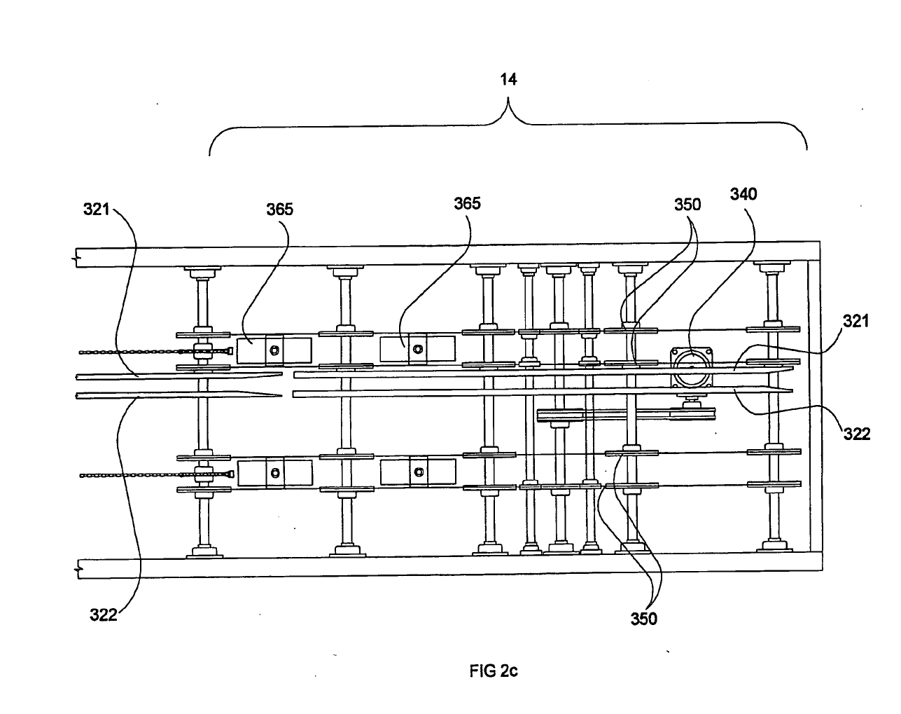

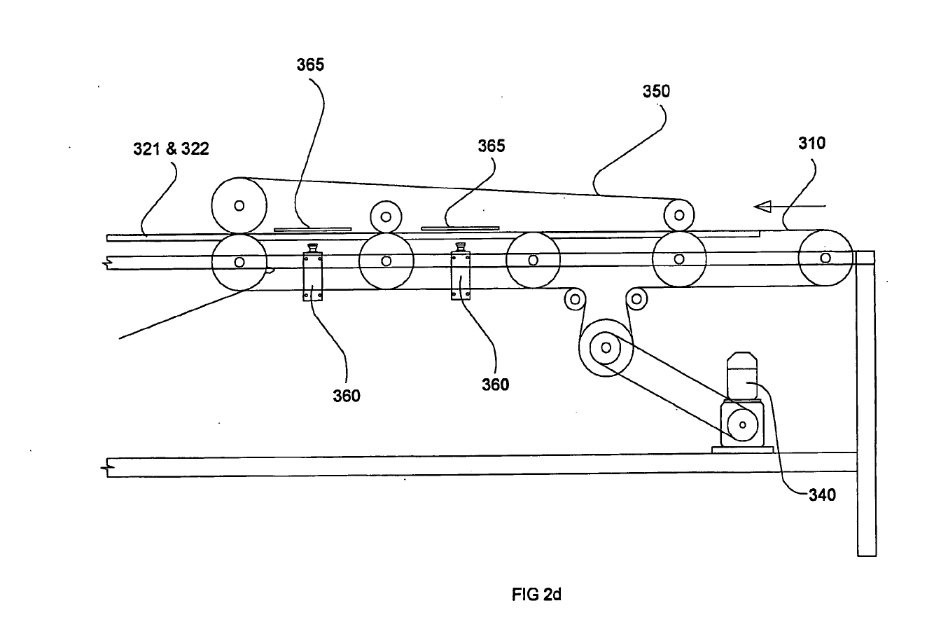

FIGS. 2a and 2b show the first conveyor belt 14 and first centring mechanism 16 in more detail. A binder 10 with binder mechanism 12 is hand laid on the conveyor belt 14. The infeed conveyor belt provides safety separation for the operator from the indexing transport system and also the length of the conveyor belt may provide a buffer to the infeed process. The conveyor belt 14 is supported on structural beams 33 which also support the drive rollers and motor powering the conveyor belt.

The first centring mechanism 16 comprises a pair of guide rails 34 which define a flared portion 36 feeding into a channel portion which is slightly wider than the binder mechanism. The initial centring mechanism 16 ensures that a binder is correctly aligned before entering the indexed transport system 30 regardless of the initial placement of the binder on the conveyor belt.

FIGS. 2c and 2d are plan and side views of a second embodiment of the feed and preliminary centring assembly 14.

Binders to be processed are placed (as indicated by arrow P) on a lower conveyor belt 310 with their binder mechanisms facing upwards and located between guide rails 321 and 322, the opposing faces of which are configured to abut the binder mechanism and align it with a predetermined datum on the apparatus (and with which the rivet release mechanism is also aligned). As in the first embodiment above, the datum may be the longitudinal centre line of the machine.

As shown in FIG. 2A, the two opposing surfaces of the guide rails 321 and 322 extend primarily in the direction Q of transport of binders through the apparatus and are configured to abut a loop of the binder mechanism in a direction perpendicular to the axis of the binder mechanism, i.e. the common axis along which the at least two loops of the binder mechanism are spaced.

The guide rails maintain the binder in its correct transverse position as it is transported through each machine process operation until the binder mechanism is finally removed from the binder flat.

In the example shown, lower conveyor belt 310 is made up of a pair of belts running side-by-side for approximately two metres and driven by a common shaft 330 that is in turn driven by an electric motor 340 via a gearbox. Lower belt 310 moves a binder to the left as seen in FIG. 2d and under a pair of non-driven but freely-rotatable upper belts 350 which apply downward pressure on the binder, ensuring traction of the binder product through the infeed process.

At the downstream end of conveyor belts 310 is provided a block and release mechanism comprising a clamping actuator, e.g. a pneumatic cylinder, and opposing clamp plate 365. When actuated e.g. by a central process controller, the actuator 360 presses a binder flat against the clamp plate 365, holding the binder stationary until such time as the main indexing system is ready to receive the binder. A number of binders can be queued on the feed assembly at any one time.

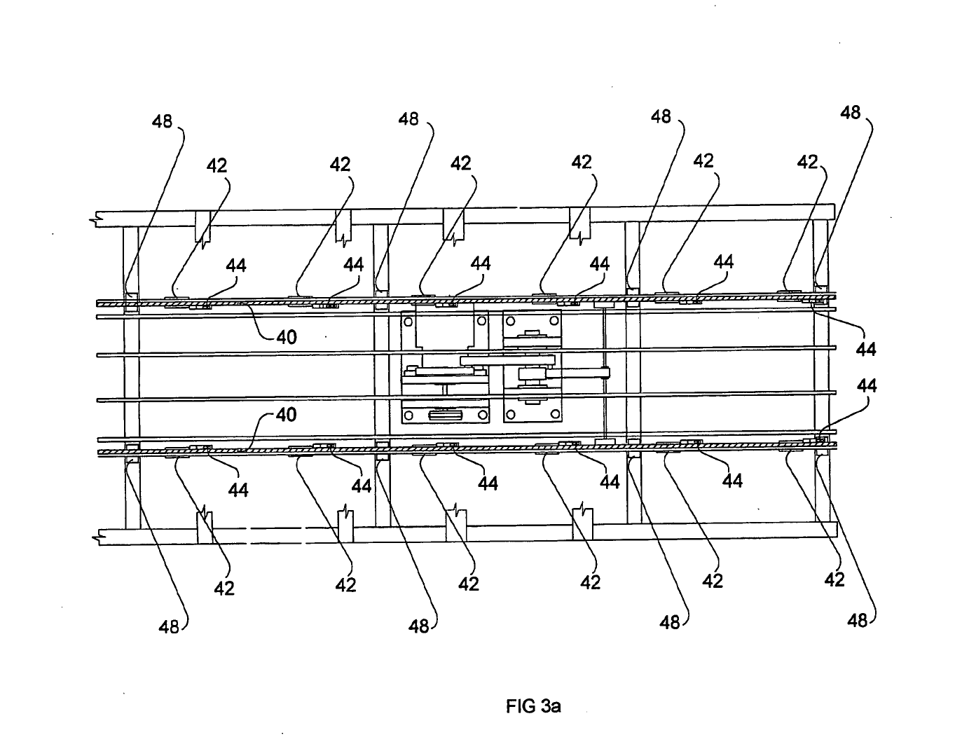

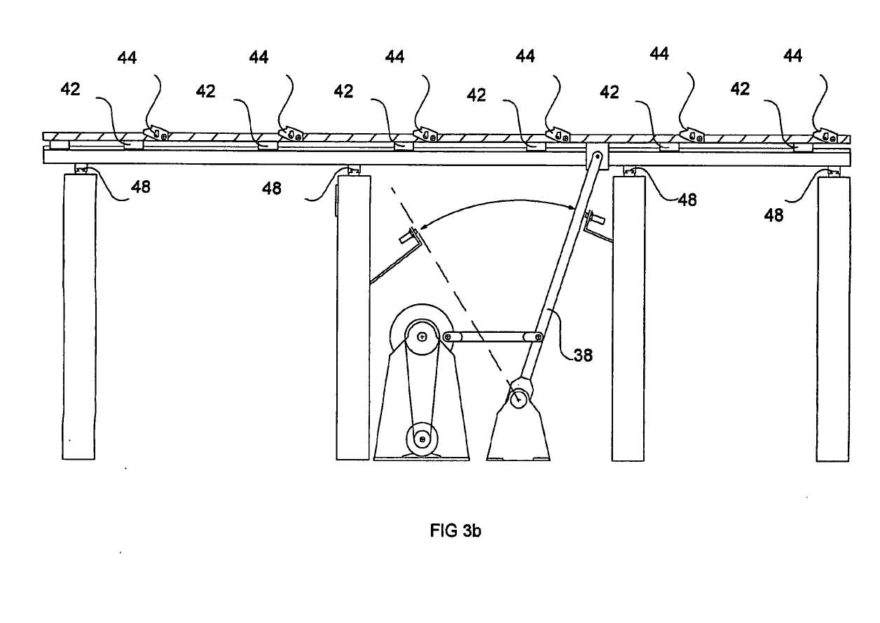

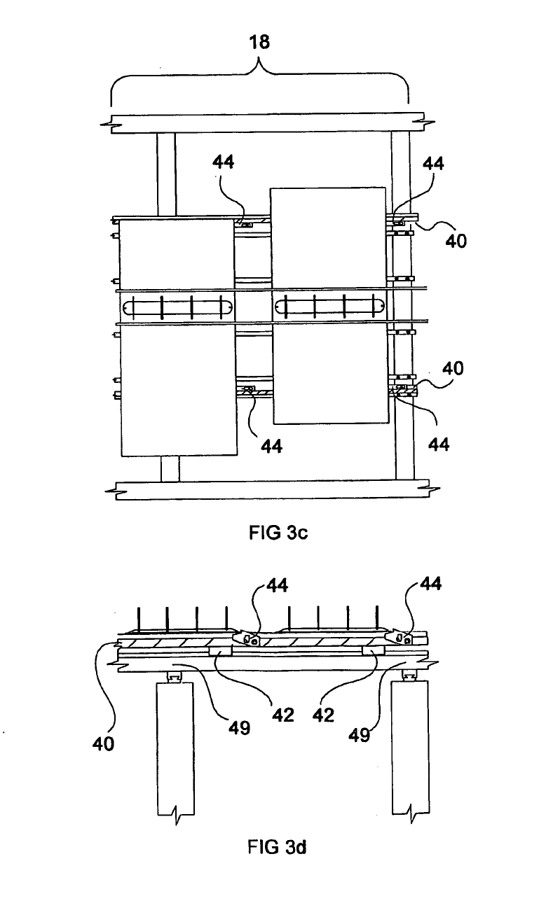

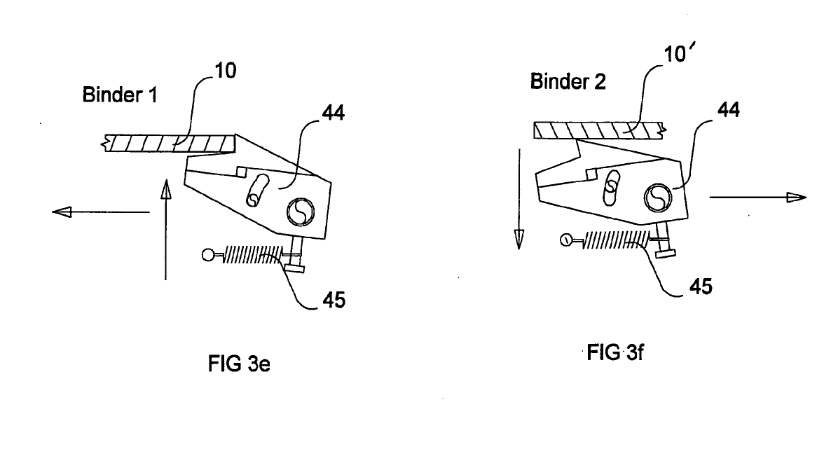

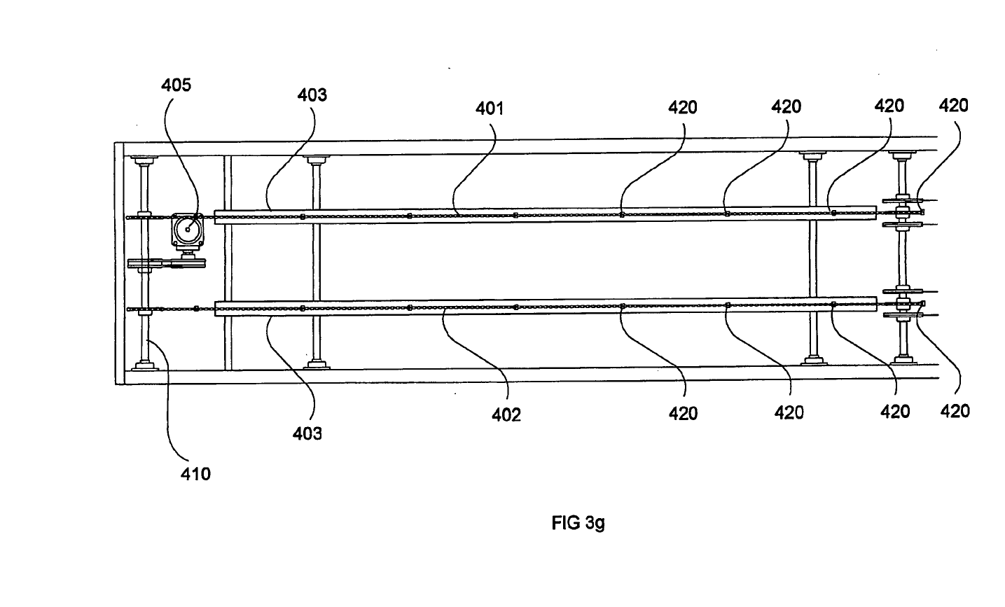

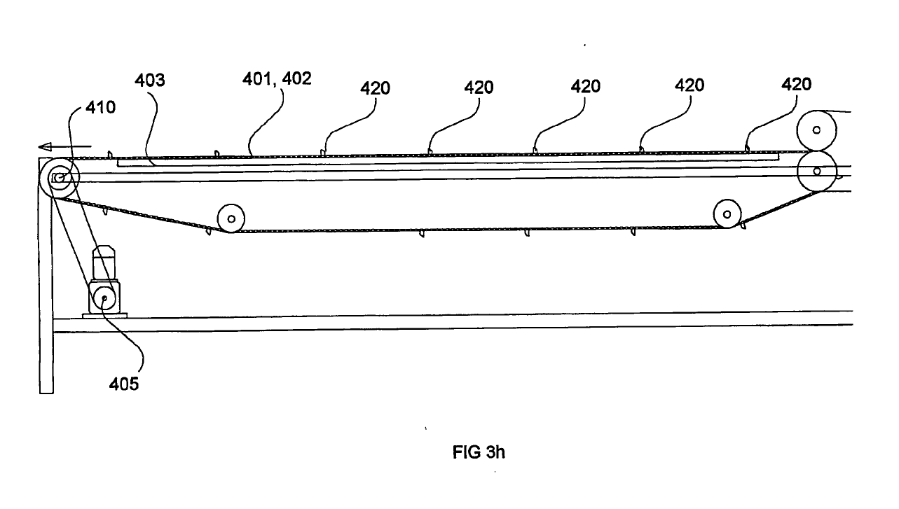

FIGS. 3a and 3b show the indexing mechanism of the embodiment of FIG. 1 in more detail, with FIGS. 3c and 3d showing the mechanism when loaded with binders. The indexing mechanism 18 operates on a swing arm 38 which produces a forward and backward motion. This oscillating motion is transmitted to a pair of moveable beams 40 which are mounted on linear bearing rails 42 and which are positioned laterally along either side of and inside the apparatus. Pusher blocks 44 are attached to the inner side of each moveable beam 40 at set intervals along its length.

The pusher blocks 44 are pivoted from the side of the beam and sprung upwards by springs 45 from their underside. The pusher blocks are shown in more detail in FIGS. 3e and 3f. As the oscillating or swing arm 38 moves forwards, the pusher blocks 44 pivot to their normal up position shown in FIG. 3e in which the upper edge of the block engages with the trailing edge of the binder 10. The binder is then pushed forward by an amount determined by the stroke of the oscillating arm. The length of the index stroke must be greater than the length of the largest binder to be processed. As the swing arm 38 moves backwards, the pusher blocks 44 are pressed down by the next trailing stationary binder 10′ against the spring and under this binder 10′ as shown in FIG. 3f. The pusher block 44 rises up when it clears the trailing edge of this binder. With the next forward movement of the swing arm 38, the pusher block 44 pushes this next binder 10′ forwards and so on.

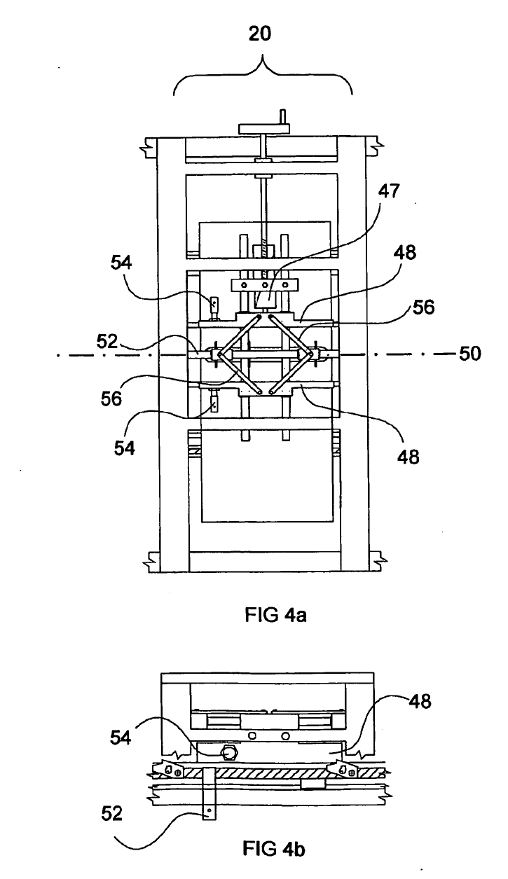

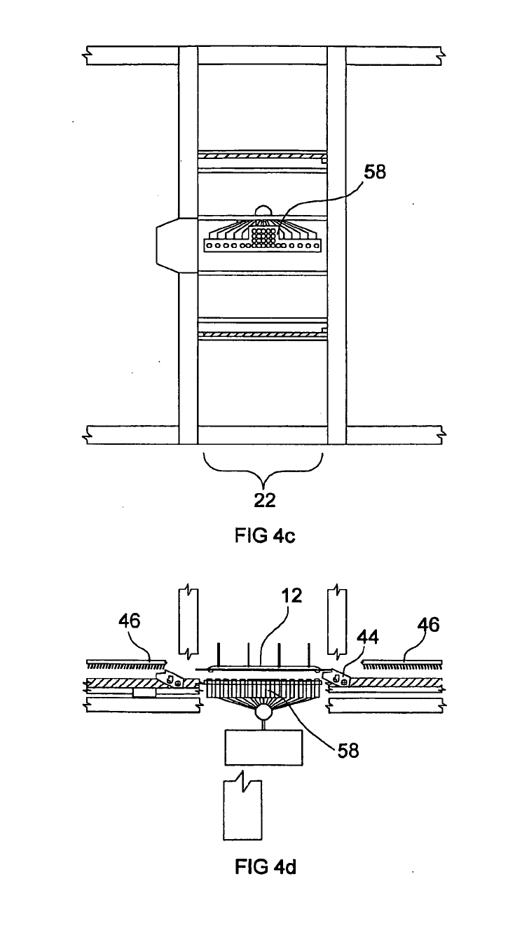

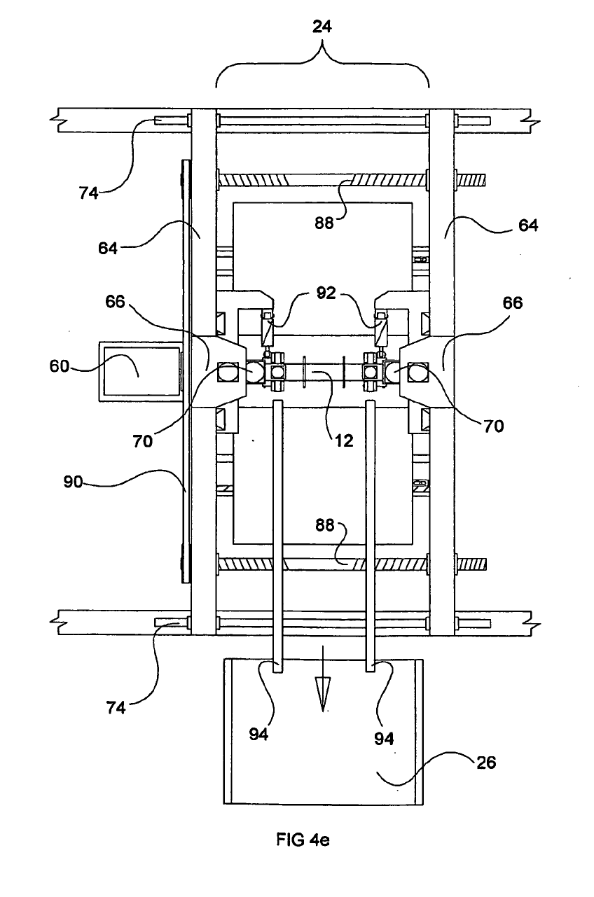

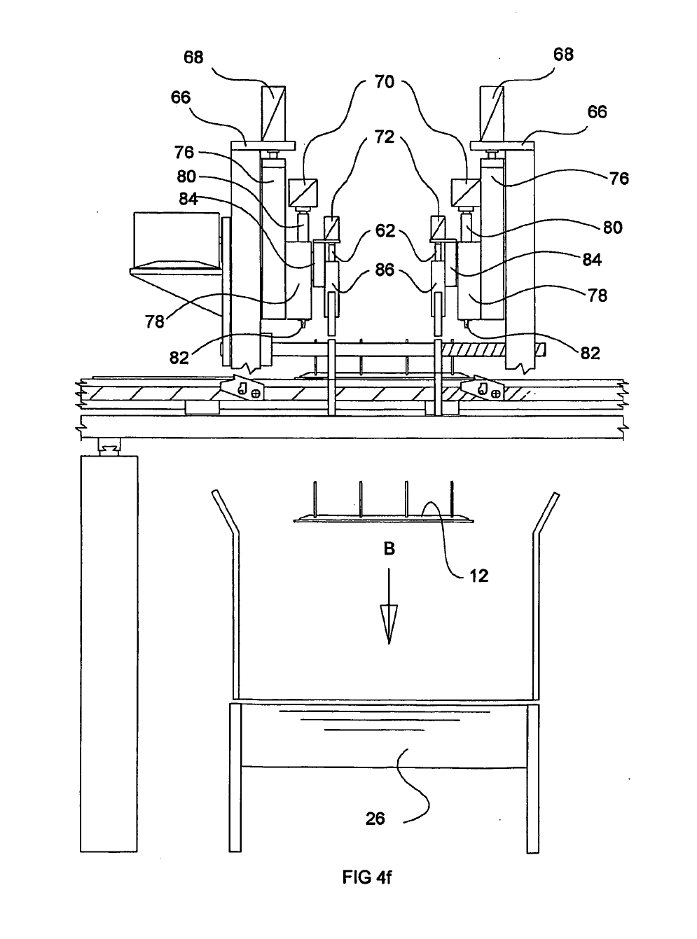

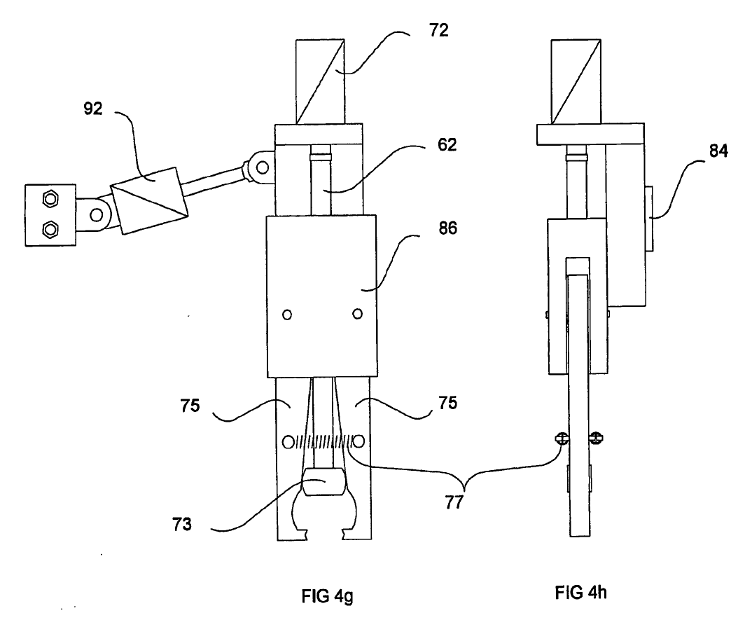

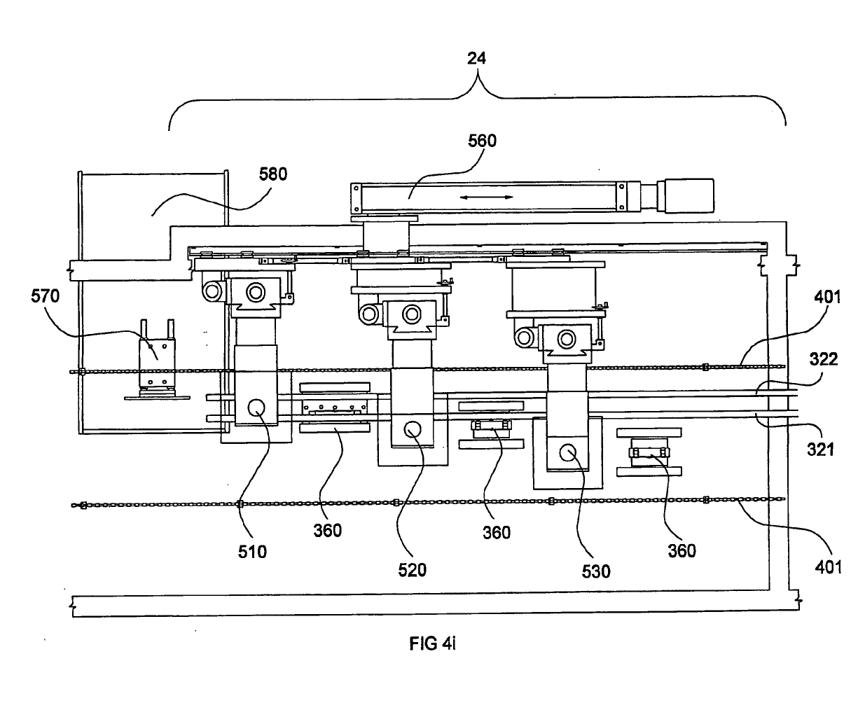

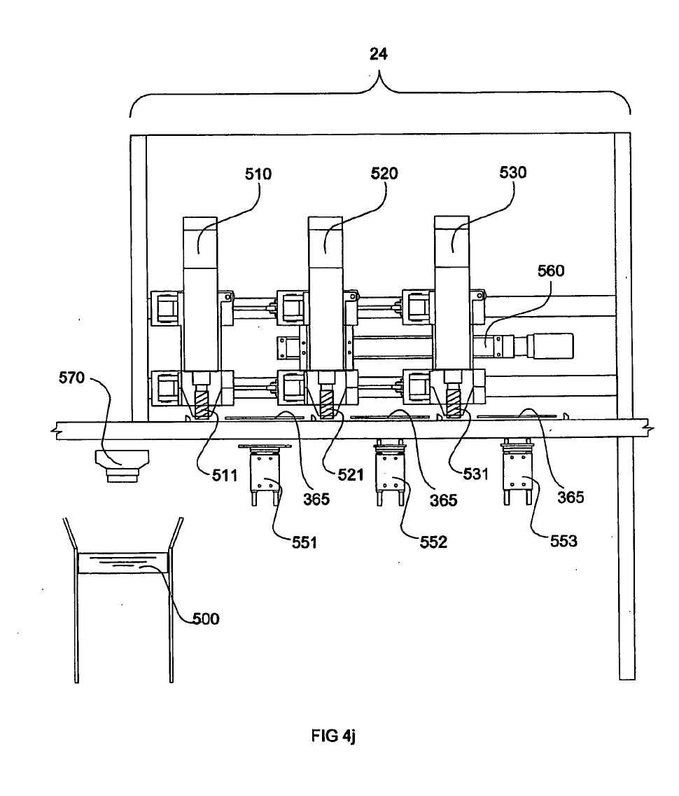

Two continuous lengths of brushing 46 (shown in FIG. 4d) are attached to either side of the apparatus. The brushing 46 applies a downward pressure to the binder flat to eliminate over run of the binder at the end of the forward stroke by the swing arm 38. The brushes 46 are static and attached to the machine frame 49.

FIGS. 3g and 3h are plan and side views of a second embodiment of the indexing transport system. This comprises a pair of chains 401, 402 each supported by a chain support 403 and driven at one end from a common shaft 410 (itself driven by electric motor 405 and gearbox). The chains extend into the rivet release mechanism 24 and through to the binder mechanism removal mechanism at the other end of the apparatus.

Along the chains at preset intervals are attached flat lugs 420 that protrude vertically above the surface of the chain and substantially perpendicular to it so as to engage with the trailing edge of a binder flat supported on the upper surface of the chain. As explained above, each binder is placed on the chain at the appropriate time by the feed assembly 14. The progression of the chains/lugs and the binders supported/driven thereby is controlled such that the binder is step indexed through the various process functions. By this step function up to four binders can have processes carried out on them simultaneously.

FIGS. 4a and 4b show the final centring, rivet sensing and rivet removal mechanisms of the embodiment of FIG. 1 in more detail. The final centring mechanism 20 comprises two moving side guides 48 connected by connecting rods 56 which are actuated by pneumatic cylinder 47 and have a scissor action. The connecting rods 56 move the side guides 48 transversely to the apparatus in an equal and parallel movement. The centre line 50 between the side guides 48 is the datum line through the apparatus.

The final centring mechanism 20 comprises a first sensor 52 which detects the presence of the binder mechanism between the side guides 48. Once a binder mechanism is detected, the side guides 48 are brought towards each other until two further sensors 54 detect when both guides 48 have made positive contact with each of the respective sides of the binder mechanism. The parallel movement of the guides 48 ensures that the binder mechanism (and hence the binder) is correctly aligned with the central datum line 50.

The centred binder is next transported to the rivet detection mechanism 22 shown in FIGS. 4c and 4d and which comprises an array 58 of sensors to detect the position and spacing of the rivet heads on the underside of the binder. The detected information is compared against known references. Furthermore, since the exact position of the pusher blocks 44 of the indexing mechanism is known, the position of the trailing edge of the binder is also known. The detected position of the rivet heads may be referenced against the position of the trailing edge and electronically calculated.

The information is fed to the rivet removal mechanism 24 where a positioning stepping motor 60 adjusts the de-riveting heads to align with the measured positions of the rivets. On the next index stroke, i.e. next forward movement of the swing arm, the measured binder is presented to the rivet removal mechanism 24, shown in further detail in FIGS. 4e and 4f.

The rivet removal mechanism 24 comprises a pair of transverse support beams 64 mounted to linear guide rails 74. The support beams 64 support the assemblies for removing the binder mechanism. The two support beams 64 are coupled by two-ball lead screws 88 each with 50% right hand thread and 50% left hand thread. A toothed pulley is fitted to one end of each screw 88 and rotation is provided via a toothed belt 90 connected to a stepping motor 60 mounted on the down stream support beam 64. By rotation of the stepper motor (and hence the toothed belt), the position of the two support beams 64 and associated assemblies are positioned to align with the measured spacing of the rivets within the binder mechanism.

The assemblies for removing the binder mechanism comprise a moveable plate 76 vertically mounted flat against the inward facing side of each support beam 64. The plates 76 are attached to the support beams 64 by vertical guide rails and bearings. A bracket 66 is attached to the top of each support beam 64. A first pneumatic cylinder 68 is attached to each bracket 66 with its shaft attached to the upper edge of the plate 76. The actuation of each first pneumatic cylinder 68 provides vertical movement of the plate 76.

Each plate 76 is also attached to a punch block 78 which has a shaft 80 passing vertically therethrough. A second pneumatic cylinder 70 is attached to the upper end of each shaft. Each second pneumatic cylinder 70 is also attached to the respective vertical moving plate 76 by a bracket. A circular punch 82 is attached to the lower end of each punch block 78.

A clamp block 86 is attached to each punch block 78 by a large pivot 84. A fourth pneumatic cylinder 92 is attached to the side of each pivot 84 whereby the clamp block 86 may be rotated sideways. A vertical shaft 62 passes through each clamp block 86. The upper end of each vertical shaft is attached to a third pneumatic cylinder to provide vertical movement of the shaft. The lower end of each shaft 62 is formed into a profiled cam 73.

As shown in FIGS. 4g and 4h, the cam 73 sits between two vertical curved lever jaws 75. These jaws 75 at their top edge are attached to either side of the clamp blocks 86 where they are pivoted. A pair of strong springs 77 connected between both jaws 75 ensures that the inside surface of the jaws remain in close contact with the cam profile.

Once a binder is fed into the rivet removal mechanism, the pair of first pneumatic cylinders 68 is energised and the assemblies are moved downwards to pre-punch position. When this action is complete, the pair of third pneumatic cylinders 72 is activated to close the clamp jaws 75 around the binder mechanism. On completion of this action, the pair of second pneumatic cylinders 70 is operated whereby the rivets are punched out by the circular punches 82.

After completion of the punch stroke, the pairs of first and second pneumatic cylinders 68, 70 are deactivated which retracts the punches 82 and lifts the complete assembly back up to the starting position. The pair of third pneumatic cylinders 72 remains activated whereby the clamp jaws 75 remain closed around the released binder mechanism 12. Thus, the binder mechanism is lifted clear of the binder to a height coincident with the upper end of the guide ramp rails 94. The pair of fourth pneumatic cylinders 92 is activated to tilt the clamp assembly backwards. Thereafter, the pair of third pneumatic cylinders 72 are deactivated to release the clamp jaws 75 and hence the binder mechanism.

The binder mechanism 12 then falls onto guide ramp rails 94 which are fitted to each of the support beams 64. The rails protrude from and are perpendicular to the side of the apparatus. Each rail 94 is aligned with each set of clamp jaws. The rails 94 are inclined at approximately 45 degrees from the horizontal so that under the effect of gravity the released binder mechanism is guided away from the de-riveting head and subsequently onto a binder mechanism feed away conveyor belt 26, as indicated by arrow B.

Each of the final centring, rivet detection and rivet removal operations requires the binder to be momentarily stationary. These stationary periods are accommodated while the indexing system is on its backstroke, i.e. while the swing arm 38 is moving backwards.

The second embodiment of the rivet releasing mechanism 24 does not require the final centring and rivet sensing systems of the first embodiment. Rather, as shown in FIGS. 4i and j, it employs three separate vertical high-speed milling heads 510, 520, 530 provided with respective vertical milling cutters 511, 521, 531 having multi-toothed end faces. The diameter of the milling cutter is chosen to be sufficiently large, typically 50 mm, so as to accommodate any expected variations in the positions of the rivets or other elements to be removed relative to the binder mechanism, thus dispensing with the need for the centring and sensing systems of the first embodiment.

The three milling heads 510, 520, 530 are arranged on a common carriage assembly 540 and, as shown in FIG. 4j, are spaced in the longitudinal direction of the apparatus such that they are each coincident with a separate index position 551, 552, 553 of a binder. A clamping actuator 360 and opposing clamp (or ‘fence’) plate 365 is provided at each index position to hold the binder still. Clamp plate 365 also provides a datum against which the depth of the milling cut is referenced: by forcing the upper surface of the binder flat against the plate, a consistent depth of cut is maintained regardless of the thickness of the binder flat material.

As shown in FIG. 4i, the milling heads are also spaced transversely to the longitudinal direction of the apparatus such that each cutter removes a different element. In the arrangement shown, cutter 511 removes the RADO™ rings, while cutter 521 removes the finger ring and cutter 531 the rivets that secure the binder mechanism to the binder flat. For any binder that only requires removal of the binder mechanism, the milling heads 510 and 520 can be switched off and raised up to clear the binder surface.

Where, as in the case of the ‘RADO™’ eyelets and binder mechanism securing rivets, there are multiple elements to be removed which are spaced parallel to the spine of the binder, a linear—typically electrical—drive 560 allows the carriage 540 supporting the mill heads 510, 520, 530 to be moved parallel to the spine of the (stationary) binder and in the longitudinal direction of the apparatus.

On completion of the milling action, the carriage is returned to its start position simultaneously with the forward indexing of each binder to the next process position, thereby reducing the overall process cycle time.

Meanwhile, positive separation of the binder mechanism from the binder flat is accomplished by the activation of a pneumatically-actuated pusher mechanism 570. The separated binder mechanism and rivet stubs fall onto a conveyor belt 580 which carries them to the side of the apparatus and onto a further conveyor belt (not shown) for sorting and inspection. A gap between belt 580 and the further belt allows the rivet stubs to fall through into a separate container.

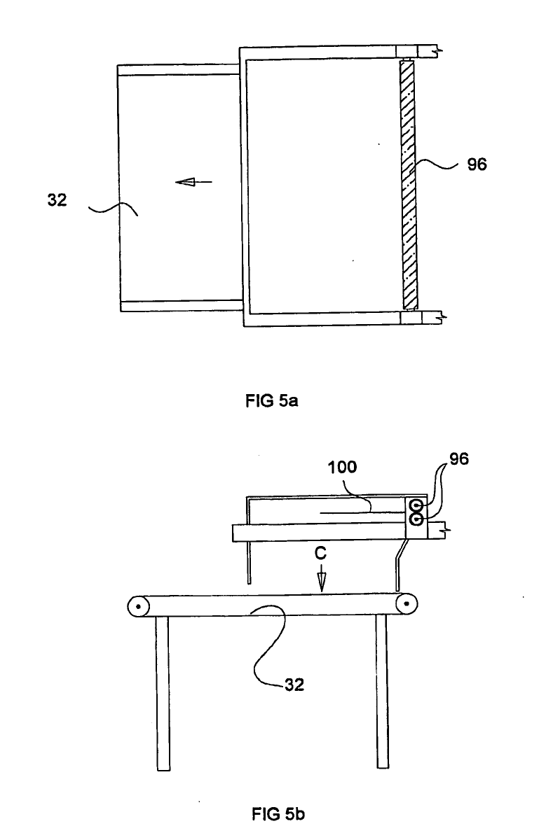

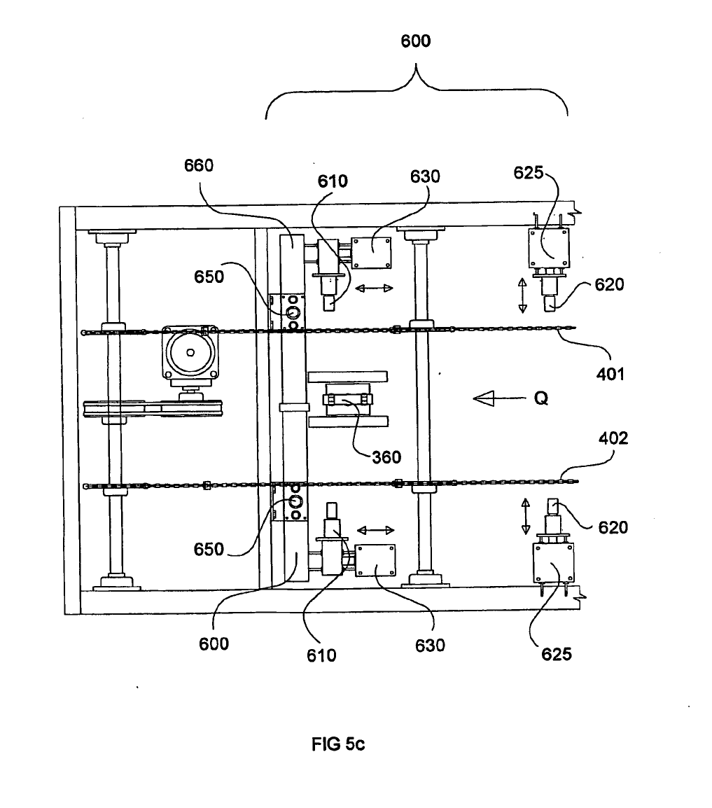

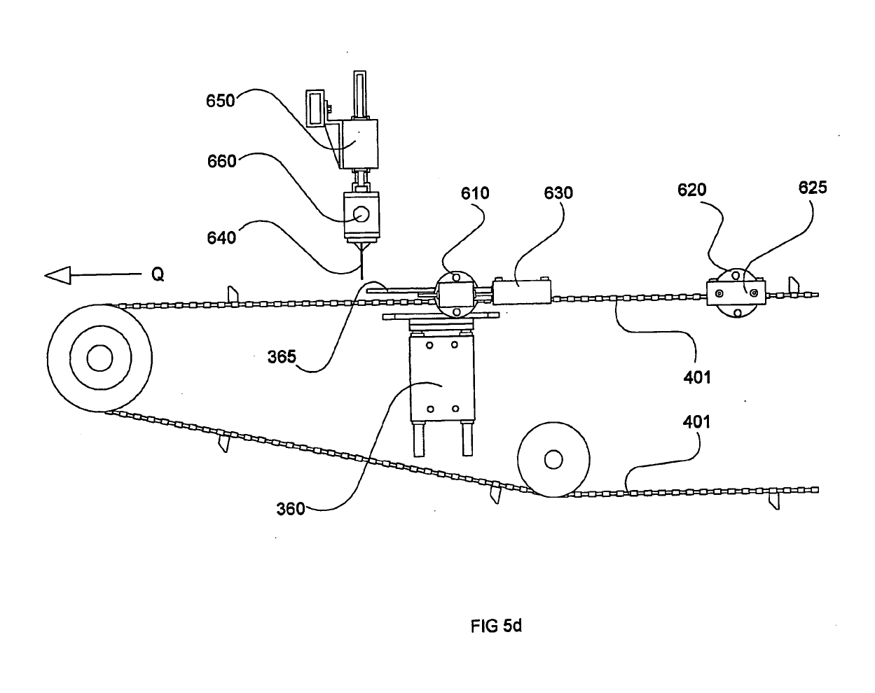

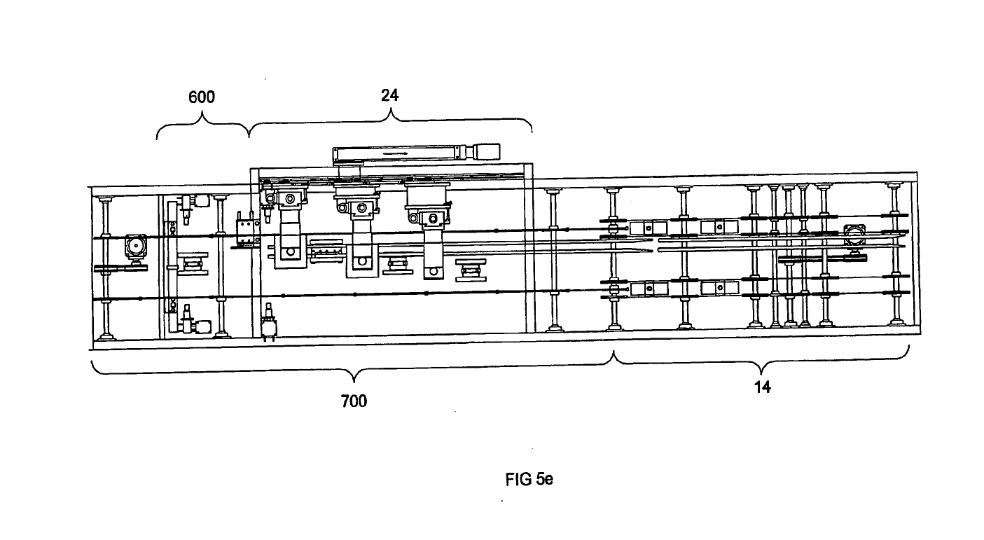

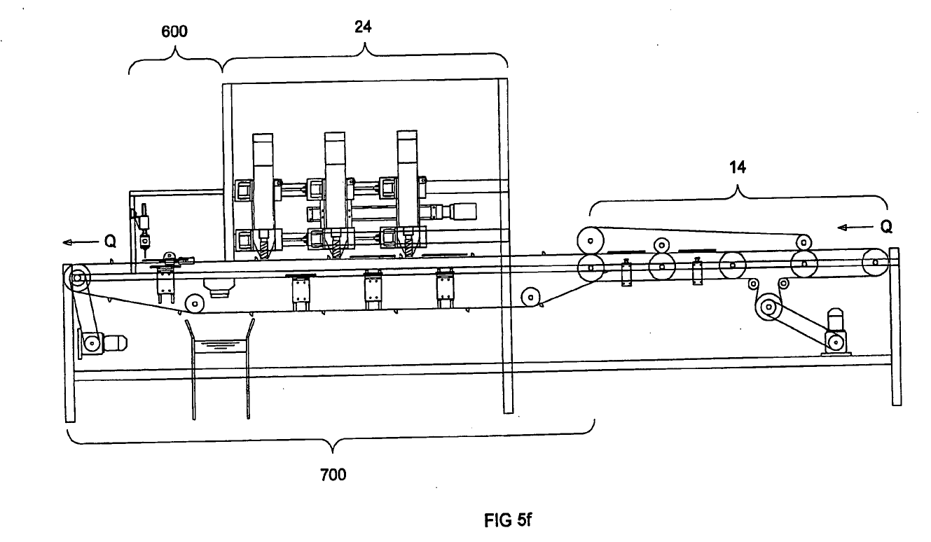

The swarf and dust generated during the milling process is removed by means of a close fitting enclosure hood (not shown) surrounding each cutter and connected to a vacuum extraction unit, e.g. via manifolds and ducting. FIGS. 5a and 5b illustrate a first embodiment of the invention whereby, once the binder mechanism has been removed, the next stroke of the index system takes the binder flat 100 to the feed out rollers 96 and thence to a feed out conveyor belt 32 (as indicated by arrow C) and onto any further processing.

FIGS. 5c and 5d illustrate a second embodiment of the invention that allows for removal of the metal edge binder ‘runners’. Such runners typically extend along the lower edges of the binder and a short way up that side edge of the binder remote from but parallel to the binder spine. As is well known, such runners allow the binder to be slid more easily onto a shelf, as well as protecting the lower edges and outer corners of the binder from wear. In the apparatus of FIG. 5c, the lower edge is positioned on the left-hand side of the binder, i.e. it is the leading edge of the binder flat in the (right-to-left) direction Q of process flow.

While the binder is held in the rivet releasing stage, first pairs of serrated jaws 620, each actuated by pneumatic cylinder 625, grip those parts of the runners extending a short way up each side edge of the binder and pull them out to the side and away from the binder edge.

First jaws 620 are then released and the next movement of the index system takes the binder flat 100 to the ‘runner removal’ station 600 where, as in previous stages, the binder flat is clamped between a clamping actuator 360 and an opposing clamp plate 365.

Serrated jaws 610 on each side of the machine then grip the (now already extended) part of each runner and pull by action of pneumatic cylinders 630 in the direction Q of process flow (right-to-left in figured 5c and 5d). This motion separates the entirety of the short side and a substantial portion of the longer side of the runner from the binder flat.

Complete separation is then effected by blades 640 which are lowered (by means of actuators 650) into the open spaces on each side of the binder between the binder leading edge and the separated portion of the metal runner. By means of linear actuators 660, the blades are then simultaneously traversed from opposite sides of the binder across its leading edge towards the centre line, thereby peeling the remaining portion of each runner away from the edge of the binder flat. The separated runners can be caught in a hopper.

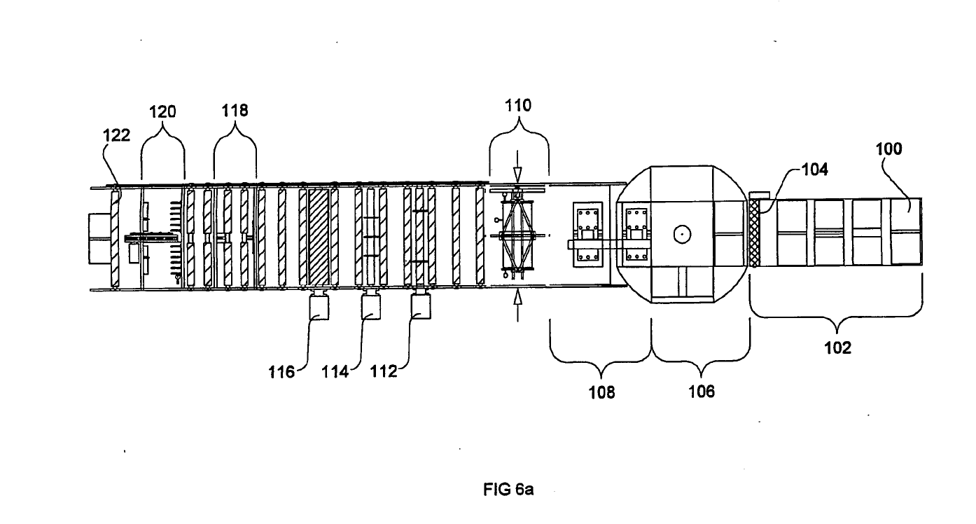

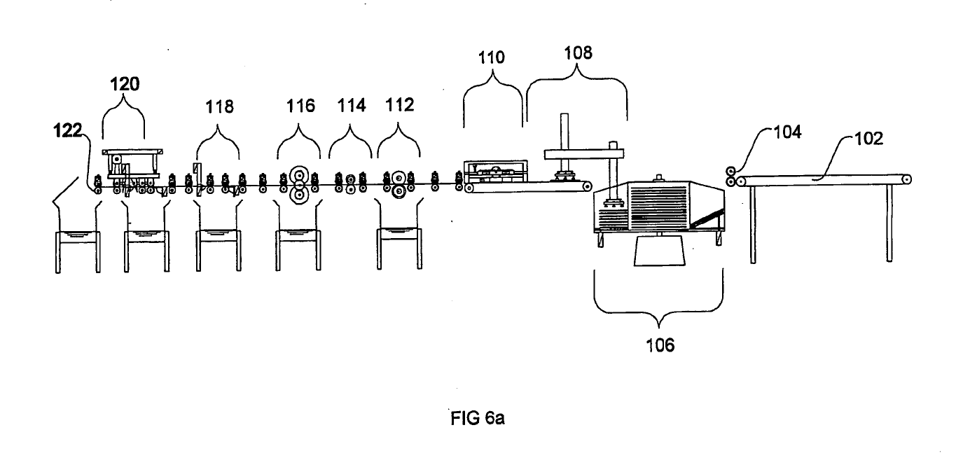

FIGS. 5e and 5f are plan and side views of apparatus according to the present invention and incorporating infeed, rivet release and runner removal sections 14, 24, 600 according to the second embodiments above. As indicated at 700 in FIGS. 5e and f, the chain-driven main transport indexing mechanism 700 of the second embodiment extends from process upstream of the rivet release mechanism 24, through the rivet and runner release mechanisms 24 and 600 to process downstream of the runner release mechanism 600. FIGS. 6a and 6b show apparatus for automatically separating the components of a binder flat 100 from which the binder mechanism has already been detached. The detachment of the binder mechanism may also be automated, e.g. as described in relation to FIGS. 1a to 5b. Alternatively, the binder mechanism may have been removed manually.

The apparatus comprises an infeed or first transport conveyor belt system 102 on which a binder flat 100 is placed by hand or fed from the out feed of the binder removal apparatus described above. As shown the binder flat 100 is placed with its spine board parallel to the central axis of the apparatus. The first conveyor belt system 102 feeds into an accelerator roller 104 which ensures positive placement of a binder flat 100 in a hopper of the rotary magazine 106. Whilst binder flats 100 are feeding into one hopper of the rotary magazine 106, binder flats 100 are also being removed from another hopper by the pick and place unit 108.

The binder flats 100 are placed by the pick and place unit 108 on a second conveyor belt which feeds them into a centring station 110. The centred binder flats 100 passes through a rotary trimming station 112, a slitting station 114 and a rotary cropping station 116. These stations trim, slit and crop the flat 100 so that thereafter the spine and side panel boards may be removed at ejection stations 118, 120. Finally, the now empty PVC cover is removed at station 122.

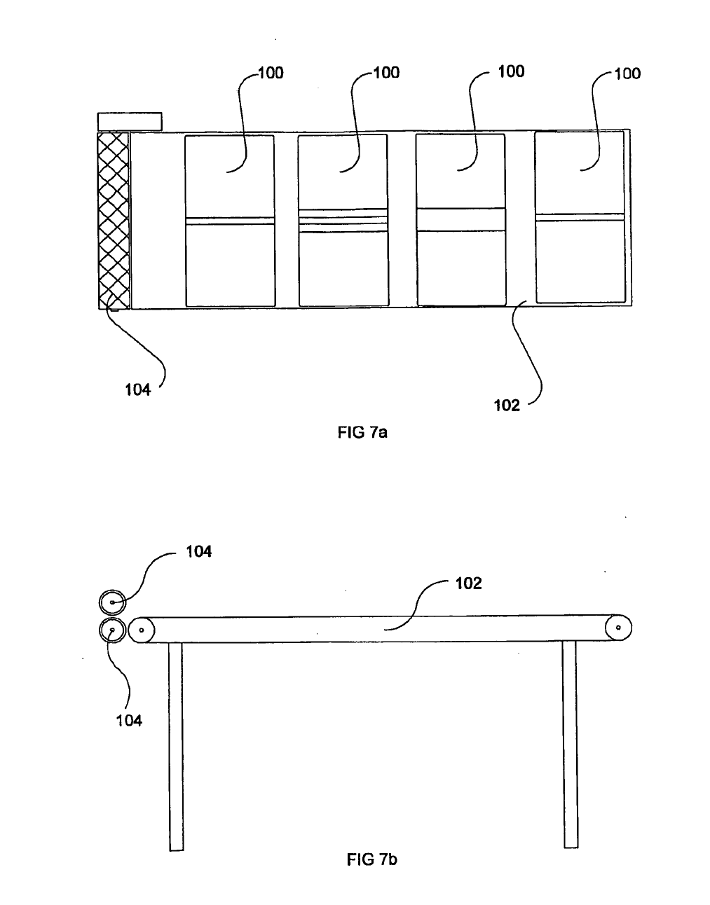

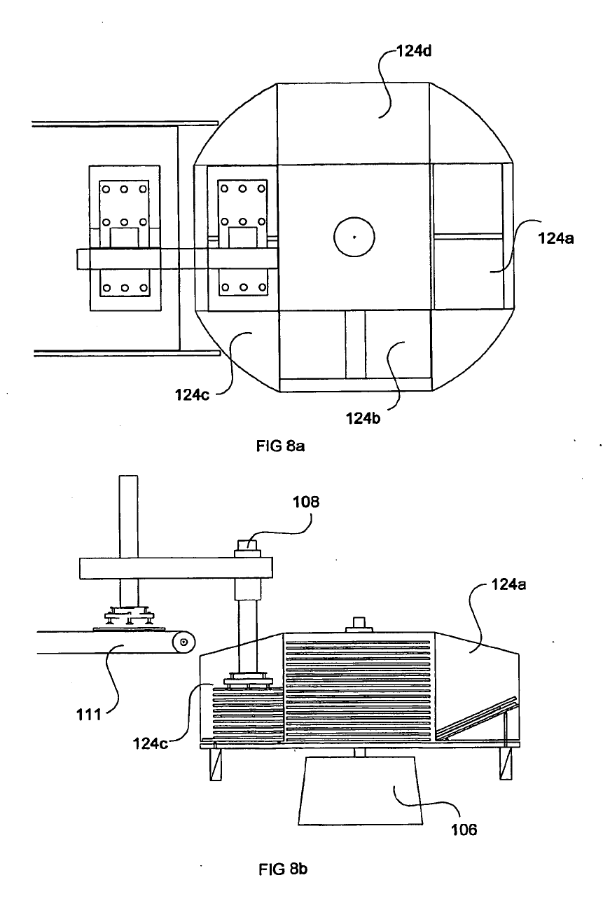

FIGS. 7a and 7b show the first or infeed conveyor belt 102 on which binder flats 100 are placed. The conveyor belt 102 provides a buffer capacity to the infeed process. An accelerator roller 104 is fitted to the feed out end of the conveyor belt 102 to ensure positive placement of the binder flat 100 in a hopper of the rotary magazine which is shown in more detail in FIGS. 8a and 8b.

The rotary magazine 106 comprises four hoppers 124a, b, c, d which are equally spaced around the rotary magazine. The rotary magazine is rotatable between four positions. In the first position, the first hopper 124a is adjacent the end of the first conveyor belt 102 so that binder flats 100 may be loaded into the hopper. The second hopper 124b is fully loaded, awaiting unloading at a position 90 degrees clockwise to the first hopper. The third hopper 124c is being unloaded by the pick and place unit 108 which is at a position 90 degrees clockwise from the position of the second hopper 124b. The fourth hopper is empty and at a position 90 degrees clockwise to the third hopper.

When the unloading of the third hopper 124c is completed, the rotary magazine 106 rotates clockwise through 90 degrees to the second position. In the second position, the full second hopper 124b is presented to the pick and place unit 108 and the empty fourth hopper 124d is adjacent the first conveyor belt 102. Once the second hopper is empty, the rotary magazine 106 rotates clockwise through 90 degrees to the third position to present the now full first hopper 124a to the pick and place unit. In the fourth position, the fourth hopper 124d is emptied by the pick and place unit 108. The use of a rotary magazine permits continuous operation of the process by smoothing out the effect of varying rates of infeed from the first conveyor belt 102.

An automatic pick and place unit 108 is mounted at the upstream end of the second conveyor belt 111. This unit 108 uses a vacuum to pick a binder from the rotary magazine hopper and place it on the second conveyor belt 111. The timing of the unit is programmed to provide the correct interval ,spacing between each binder flat 100 through the process of separating the components.

Such pick and place units are widely employed for transferring all sizes of item. The configuration of each unit is specific to the individual application but generally uses components from a standard range. The unit comprises means for gripping the product to be transferred, e.g. a vacuum sucker as shown or clamping jaws. Pneumatic or electric motors operate a slide rail or pivoted arm arrangement to lift an item. Similarly, pneumatic or electric motors may operate a slide rail or pivoted arm arrangement to transport an item sideways. There is also some form of electronic feedback and position control.

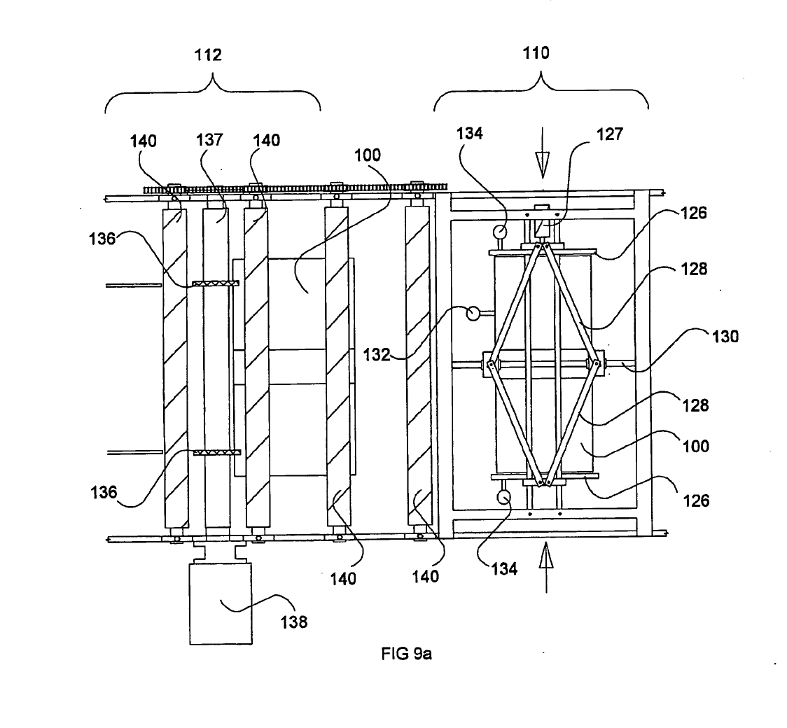

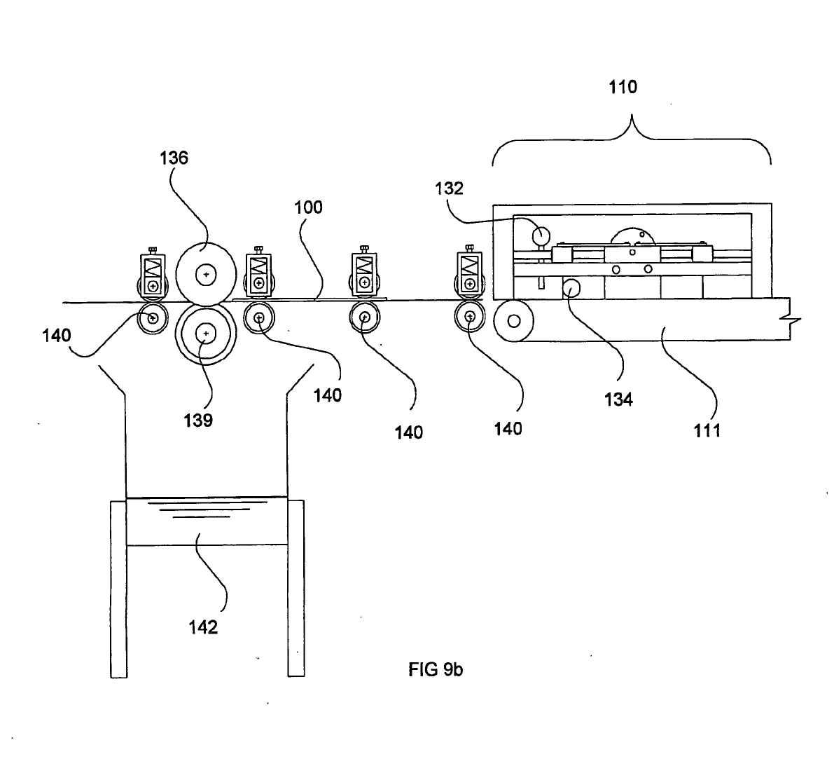

FIGS. 9a and 9b show more detail of the centring station comprises two moving side guides 126 connected by connecting rods 128 which are pneumatically operated by cylinder 127 and have a scissor action. The connecting rods 128 move the side guides 126 transversely to the apparatus in an equal and parallel movement. The centre line 130 between the side guides 126 is the spine datum line through the apparatus. The centre line of each binder spine must be aligned with the spine datum line to ensure alignment with the appropriate slitting knife.

The final centring mechanism 110 comprises a first sensor 132 which detects the presence of the binder flat 100 between the side guides 126. Once a binder mechanism is detected, the side guides 126 are brought towards each other until two further sensors 134 detect when both guides 126 have made positive contact with each of the respective edges of the binder flat 100. The parallel movement of the guides 126 ensures that the binder flat 100 is correctly aligned and centred with the spine datum line 130.

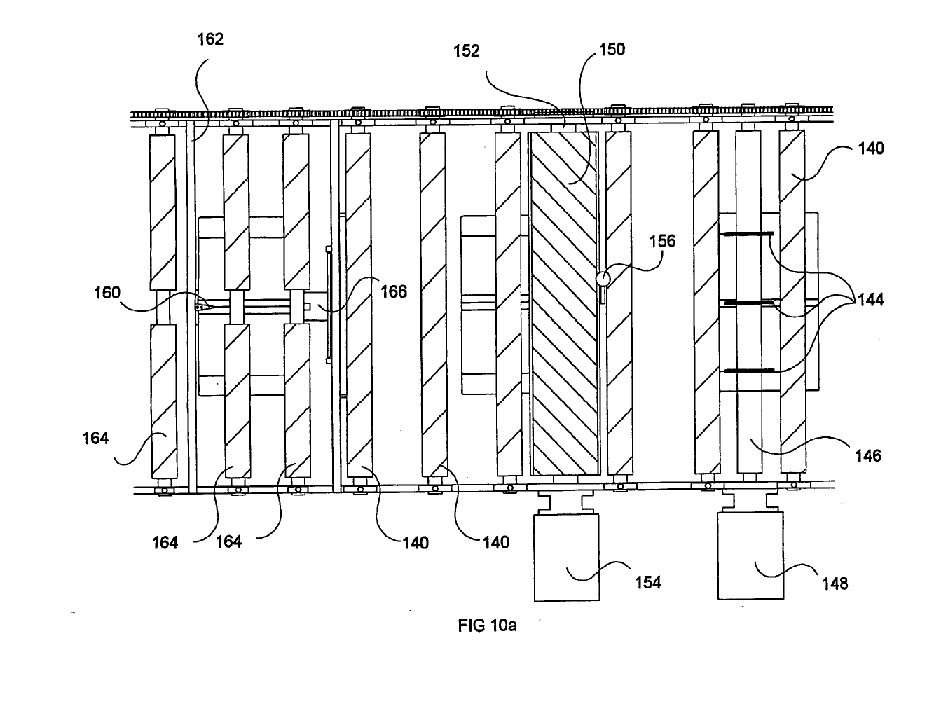

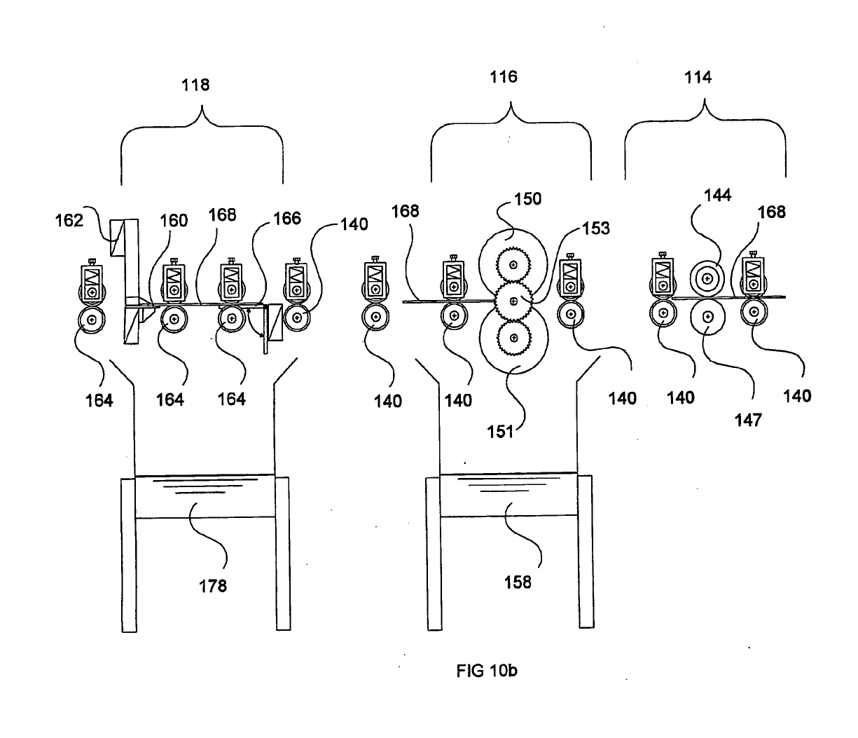

The centred binder flat 100 is fed through three pairs of rotating nip rollers 140 to the rotary trimming station 112. This station comprises two pairs of continuously rotating circular shearing blades 136 mounted on an upper shaft 137 driven by an electric motor 138. A lower shaft 139 comprising two hardened circular collars is set below the upper shaft 137 so that the blades 136 are in very light rubbing contact with the collars. In this way, the collars and blades together operate as a rotating scissor action. The distance d between the blades 136 and collars is set for a standard binder width. If the binder is wider than the standard size, the excess material will be removed. The cut away material drops into a hopper 142 and from there to a feed away conveyor belt for further processing if required. Additional nip rollers 140 transport the trimmed binder flat 100 to the slitting station 114 which is shown in more detail in FIGS. 10a and 10b.

The slitting station 114 comprises three continuously rotating circular slitting knives 144 set on a rigid shaft 146 driven at one end by a motor 148. The height of the knives 144 is set so that a kiss cut is made through the top layer of PVC as the binder passes beneath the knives. This slitting action releases the transverse grip that the PVC cover has on the board core but the knives do not cut into the board core. A lower roller 147 supports the binder flat to prevent it deflecting away from the action of the slitting knives. The rotation of the roller 147 also assists with the forward motion of the binder flat. The slit binder flat 100 is then conveyed to the cropping station 116 again by nip rollers 140.

The cropping station 116 crops the leading and trailing edges from the binder. In this way, the rounded corners, if any, of the binder are removed and the ends of the binder are opened enabling the side panel'boards to be pushed out. The cropping station comprises a drum 150 and two heavy-duty blades set in the circumference of the drum. The blades are 180 degrees apart and mounted co-axially with the drum 150. The drum 150 is mounted on a shaft 152 which is electrically driven via a stepping motor 154. A lower roller 151 supports the binder flat to prevent it from deflecting away from the blades and to provide a solid base on which the blade may act. Rotation of the lower roller 151 also assists with forward motion of the binder flat. The blades are set such that they protrude from the drum so as to cut through and crop the binder flat without contacting the lower roller 151. A drive gear 153 connects the drum 150 and lower roller 151. The cropping station 116 is set transversely across to the apparatus.

The cropping station 116 comprises a sensor 156 which detects the presence of the leading edge of a binder flat 100 at a predetermined position on its approach to the cropping station 116. The sensor 156 sends a detection signal which controls the stepping motor 154 to rotate the drum 150, with its inset blades, at a speed consistent with the forward speed of the binder flat 100. The cropping action is timed so that the leading blade crops the leading edge of the binder and the trailing blade, the trailing edge of the binder.

The waste material from the cropping action drops down into a hopper 158 and from there to a feed away conveyor belt for further operation if required. The remaining binder material is next transported to the spine eject station 118 by further nip rollers 140.

The spine eject station 118 which comprises a profiled static pusher blade 160 mounted on a transverse beam 162. The height of the blade 160 is set such that contact is made with the side panel through the open leading edge of the binder flat 100. The binder flat is transported through the spine eject station on a different type of nip rollers 164. In contrast to the normal nip rollers used throughout the rest of the machine, the nip rollers 164 in this section do not have a constant cross-section. The circumference diameter of these nip rollers 164 is reduced in the middle of their span to prevent any pressure being applied to the spine section of the binder flat.

As the binder flat progresses through the spine eject station 118 by the action of the nip rollers 164 against the two side panel boards of the binder flat, the lead edge of the spine board contacts the static pusher 160. As the forward motion continues, the spine board is held stationary and the rest of the binder flat continues to move. A small pneumatically actuated hinged flap 166 supports the emerging spine board 168. Once the rest of the binder flat has moved to the next station, the spine board 168 is left behind, supported only by the flap 166. The flap 166 is then actuated downward, thus removing any remaining support from the spine board 168 which in turn falls down on to a feed away conveyor belt 178.

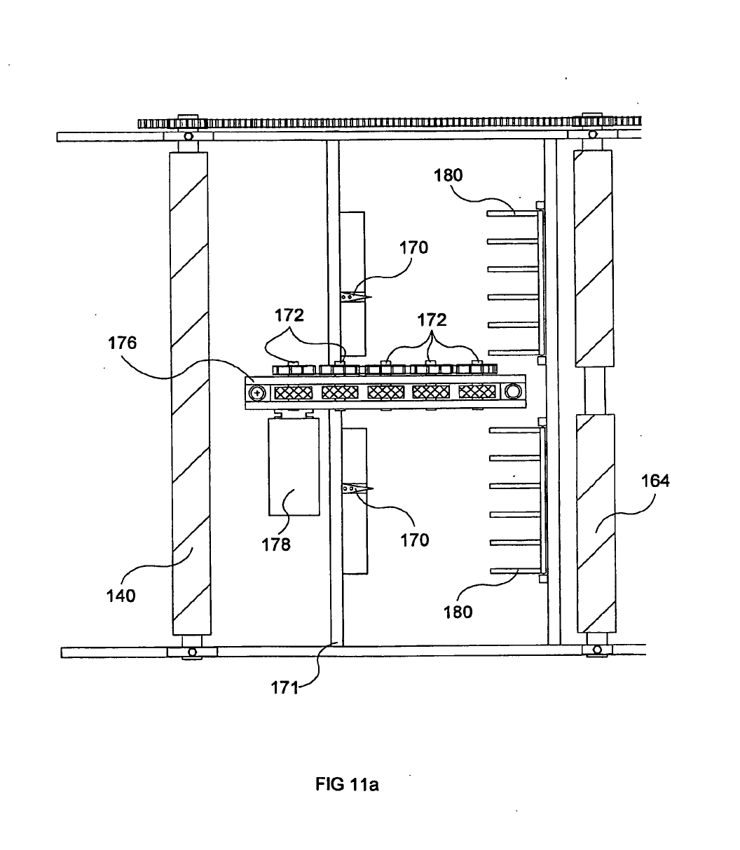

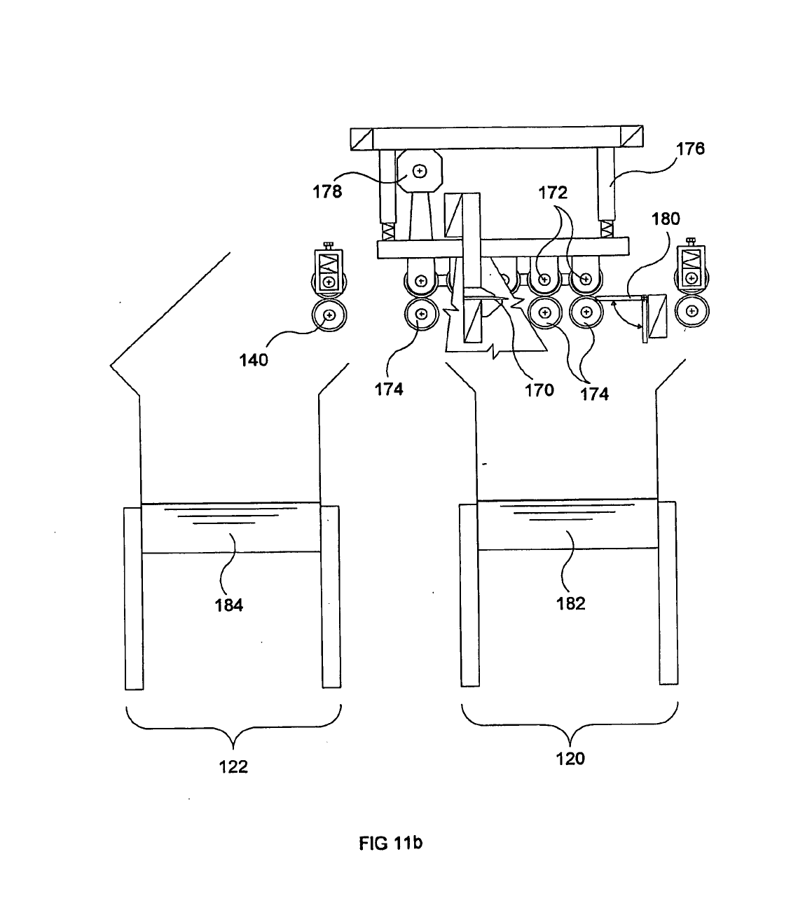

The remaining parts of the binder flat are then moved on to the panel eject station 120 which is configured on the same principle as the eject spine station and is shown in more detail in FIGS. 11a and 11b. The panel eject station 120 comprises two special profiled stationary pusher blades 170 which are each mounted on a transverse beam 171. The positions of the pusher blades 170 along the beam 171 are aligned with the slits in the PVC cover applied by the slitting station 114. The height of the pusher blades 170 is set such that contact is made with the side panel boards through the open leading edge of the binder.

Another set of specially adapted spine nip rollers 172, 174 are used to transport the binder flat through the panel eject station 120. The nip rollers are designed to act only the spine area of the binder flat, this now being free of its spine board. In this way, the ejection of the side panel boards in not obstructed by the nip rollers. The upper set of nip rollers 172 have of a width consistent with that of the spine area of the binder flat spine. They are grouped together on a single sprung loaded frame 176 and are driven by chain from a single electric motor 178. The lower set of nip rollers 174 are of the same configuration as the upper set except that those are not sprung loaded.

As the binder flat progresses through the panel eject station 120 by the action of the spine nip rollers 172, 174, the lead edge of the side panel boards contacts the static pusher blades 170. As the forward motion continues, the two side panel boards are held stationary and the PVC cover continues to move away. Two pneumatically actuated hinged flaps 180 support the emerging boards. Once the PVC cover has moved to the next station, the two panel side boards are left behind, supported only by their associated flaps 180. The flaps 180 are then actuated downward, thus removing any remaining support from the boards which fall down on to a feed away conveyor belt 182.

The now limp PVC cover is transported by conventional full width nip rollers 140 to the feed out station 122 at the end of the apparatus. The cover drops in to a hopper 184 and on to a conveyor belt for transport to a bulk collection container.

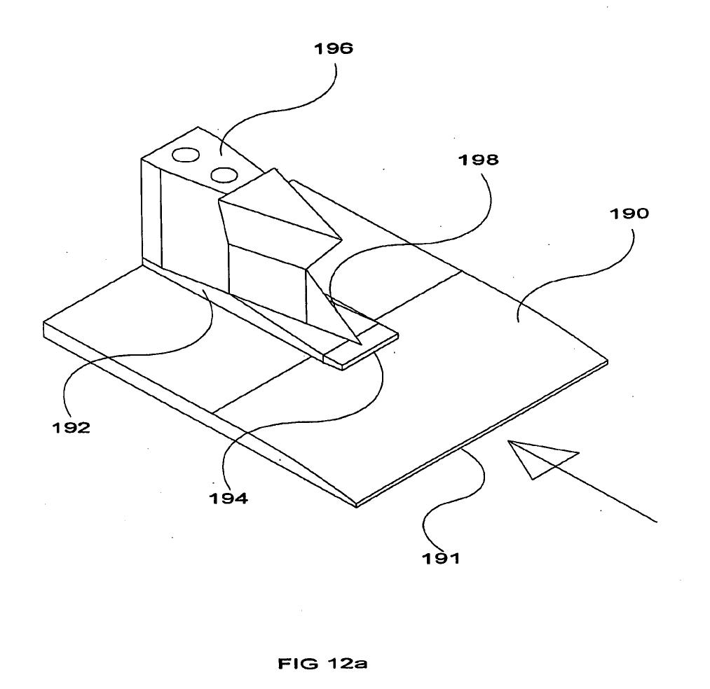

FIGS. 12a and 12b show the shape of the pusher blades 160, 170 in more detail. The pusher blades comprise base plate 190 which slides under a binder flat 100, a board engaging member 192 and a connecting body 196. The thickness of the base plate 190 is reduced at its leading edge 191. The board engaging member 192 is smaller than the base but has a similar shape to the base 190. The base plate 190 is mounted on transverse beam 200 and the board engaging member 192 is attached to vertical support frame 202 via a connecting body 196. The trailing edges of all components are aligned.

The base plate 190 and the board engaging member 192 are mounted independently of each other and are set apart such that the space between the upper surface of the base 190 and the underside of the board engaging member 192 is equal to that of the thickness of the PVC skin on the lower side of the binder flat As shown in FIG. 12b, the leading edge 194 of the board engaging member 192 slides between the PVC skins to contact the inner board. The lower PVC skin passes between the base plate 190 and the board engaging member 192.

The connecting body 196 is mounted on the board engaging member and has a triangular plough shaped protrusion 198 which follows a slit in the upper skin of the binder flat. The action of the plough protrusion 198 is to open the PVC skin to release any remaining hold on the inner board.

In the embodiments described above, the binder flat comprises a spine board, two side panel boards and a PVC cover. However, the removal process described may be used for binder flats having covers made from other suitable materials, e.g. polypropylene or paper, provided such skins are not adhered to the board.

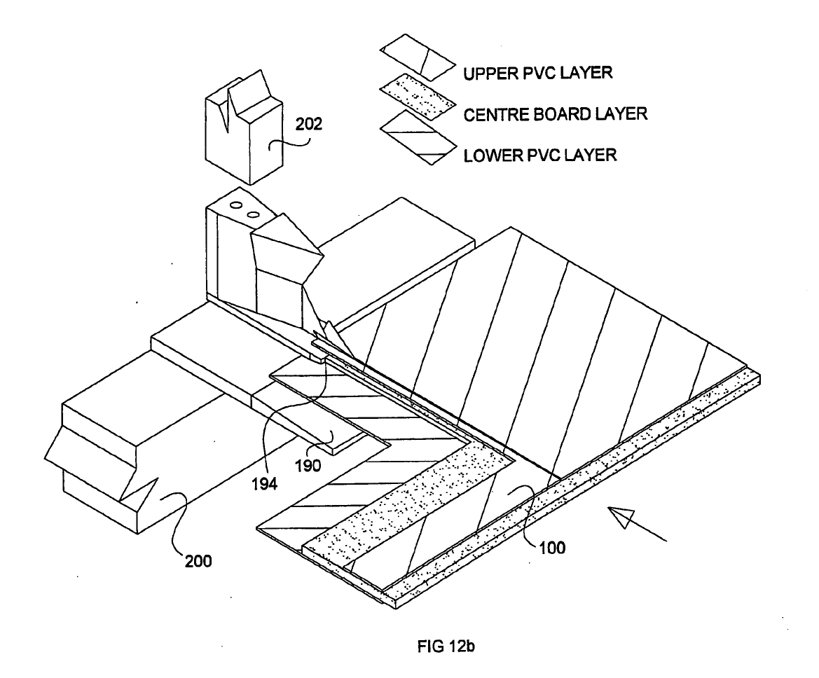

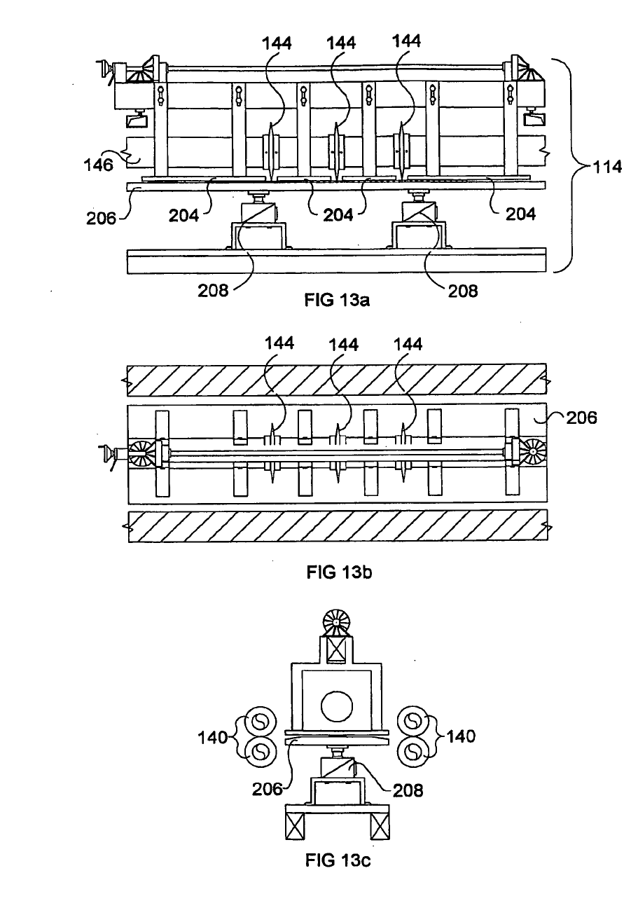

FIGS. 13a to 13c show an alternative second cutting or slitting station 114′ which addresses the problem of variation in thickness of the binder flat. As before, the slitting station 114′ comprises three continuously rotating circular slitting knives 144 set on a rigid shaft 146 driven at one end by a motor (not shown). This alternative slitting station 114′ also comprises flat horizontal metal fence plates 204 which are installed on both sides of each knife 144 and are support from above. The plate support incorporates an adjusting mechanism whereby the height of the underside of the plates may be manually set with reference to the lowest point of each knife. The difference in height between the underside of each plate and the lowest point of each knife 144 is set so that a kiss cut is made through the top layer of PVC as the binder passes beneath the knives.

The lower roller of the previous design is replaced with a horizontal metal bed plate 206 supported on vertical guide rods and bearings (not shown). The shaft of at least one pneumatic cylinder 208 is attached to the underside of the bed plate 206 whereby the height of the bed plate 206 may be varied by actuation of the pneumatic cylinders.

The pneumatic cylinders 208 apply sufficient pressure to maintain positive contact of the upper surface of the binder flat with the underside of the fence plates 204. The distance between the fence plates and the tip of the knives is set as described above. Accordingly, if the desired positive contact between the binder flat and fence plates is achieved, the depth of slitting cut applied to each binder flat will be equal. The activation pressure of the pneumatic cylinders is low whereby variations in the thickness of the binder flat may be accommodated without variation in the depth of slitting cut. The thicker the binder flat, the more the compression of the cylinder and the higher the pressure applied to maintain the desired positive contact between the binder flat and fence plates.

1. Apparatus for removing binder mechanisms from binders, the apparatus comprising:
a transport mechanism for transporting binders in series through the apparatus;
an alignment mechanism configured to align the binder mechanisms with a predetermined datum relative to the apparatus;
a rivet releasing mechanism positioned relative to the predetermined datum for releasing at least one rivet holding each binder mechanism to its respective binder;
a binder mechanism removal mechanism for removing each binder mechanism from its respective binder once the at least one rivet has been released by the rivet releasing mechanism; and
an indexing mechanism for indexing transport of binders through the apparatus in synchronism with operation of the rivet releasing mechanism.

2. Apparatus according to claim 1, wherein the indexing mechanism comprises a swing arm having a forward and backward motion and at least one moveable beam connected to the swing arm whereby the beam pushes a binder forwards during the forward motion of the swing arm.

3. Apparatus according to claim 1, wherein the indexing mechanism comprises a moveable member configured to engage and move a binder forwards, the moveable member being kinematically connected to an intermittent driver synchronised with the operation of the rivet releasing mechanism.

4. Apparatus according to claim 3, wherein the moveable member is attached to a chain driven by the intermittent driver.

5. Apparatus according to claim 1 and comprising a sensing mechanism for sensing the location of said at least one rivet holding the binder mechanism to the binder.

6. Apparatus according to claim 5, wherein the sensing mechanism comprises an array of sensors which detect the location of the rivets.

7. Apparatus according to claim 5, wherein the rivet releasing mechanism comprises a punch head which is adjustable depending on the sensed location of the rivets.

8. Apparatus according to claim 1, wherein the rivet releasing mechanism comprises a milling head.

9. Apparatus according to claim 8, wherein the milling head is a horizontal mill comprising a cutter and a drive shaft both of which are mounted horizontally.

10. Apparatus according to claim 8, wherein the milling head is a vertical mill comprising a cutter and a drive shaft which are all mounted vertically.

11. Apparatus according to claim 8 and comprising a plurality of milling heads spaced transversely to the direction of transport of the binder through the apparatus.

12. Apparatus according to claim 1, wherein the indexing mechanism is configured to hold the binder stationary while at least one rivet of said binder is being released by said rivet releasing mechanism.

13. Apparatus according to claim 12, wherein the indexing mechanism comprises a clamp actuable to engage the binder flat and hold the binder stationary.

14. Apparatus according to claim 12, wherein the rivet removal mechanism comprises a milling head is configured to move relative to said stationary binder.

15. Apparatus according to claim 1, wherein the binder mechanism removal mechanism comprises a clamp assembly which clamps around the binder mechanism.

16. Apparatus according to claim 15, wherein the clamp assembly is rotatable to rotate a clamped binder mechanism away from the binder once the rivets have been removed.

17. Apparatus according to claim 1, wherein the alignment mechanism is configured to abut the binder mechanisms of the binders, when transported in series.

18. Apparatus according to claim 17, wherein the alignment mechanism has two opposing surfaces configured to abut the binder mechanism of the binder.

19. Apparatus according to claim 18, wherein the two opposing surfaces extend primarily in the direction of transport of the binder through the apparatus.

20. Apparatus according to claim 18, wherein the binder mechanism comprises at least two loops spaced along a common axis, wherein each of said two opposing surfaces is configured to abut a loop of the binder mechanism in a direction perpendicular to said common axis.

21. Apparatus according to claim 1 and comprising a further alignment mechanism having a pair of guides configured to move in an equal and parallel movement towards the edges of a binder whereby the binder is aligned correctly relative to the apparatus.

22. Apparatus according to claim 21, wherein the guides are coupled together by connecting rods which operate in a scissor action.

23. Apparatus according to claim 1 and further comprising at least one moveable jaw configured to engage an edge runner of said binder and move relative to said binder, thereby at least partially separating said runner from said binder.

24. Apparatus according to claim 23, wherein said indexing mechanism is configured to hold the binder stationary while said moveable jaw is in engagement with said edge runner.

25. Apparatus according to claim 24, wherein the indexing mechanism comprises a clamp actuable to engage a binder flat and hold the binder stationary.

26. Apparatus according to claim 23 and further comprising a member insertable between said runner and said binder, thereby to separate said runner and said binder.

27-43. (canceled)

44. An automated method for removing binder mechanisms from binders, the method comprising:
aligning the binder mechanisms with a predetermined datum relative to the apparatus;
releasing at least one rivet holding each binder mechanism to its respective binder by means of a rivet releasing mechanism positioned relative to the predetermined datum;
removing each binder mechanism from its respective binder once the at least one rivet has been released by the rivet releasing mechanism; and
indexing the binders in series through the apparatus in synchronism with operation of the rivet releasing mechanism.

45. (canceled)
